(19) United States
(12) Patent Application Publication
(10) Pub. No.: US 2025/0086450 A1
(43) Pub. Date: Mar. 13, 2025

(54) EFFICIENT COMMUNICATION AND COMPUTATION FOR SPLIT-TRAINING OF MACHINE LEARNING MODELS

(71) Applicant: QUALCOMM Incorporated, San Diego, CA (US)

(72) Inventors: Kyle Chi GUAN, New York, NY (US); Qing LI, Princeton Junction, NJ (US); Himaja KESAVAREDDIGARI, Bridgewater, NJ (US); Kapil GULATI, Belle Mead, NJ (US); Hong CHENG, Basking Ridge, NJ (US)

(21) Appl. No.: 18/463,108

(22) Filed: Sep. 7, 2023

(51) Int. Cl. G06N 3/08

(52) U.S. Cl. CPC G06N 3/08

(57) ABSTRACT

Certain aspects of the present disclosure provide techniques and apparatus for improved machine learning training process. Input data for a first portion of a neural network is accessed, and output data is generated based on processing the input data using the first portion of the neural network. At a first point in time, the output data is transmitted to a second computing system for the second computing system to update one or more parameters of a second portion of the neural network based on the output data. It is determined, at a second point in time subsequent to the first point in time, that one or more communication criteria are not satisfied. In response to the determining, reduced communication training of the neural network is performed, the performing comprising reducing an amount of data transmitted for one or more rounds of training.

### INTRODUCTION

Aspects of the present disclosure relate to machine learning.

A wide variety of machine learning model architectures have proliferated and have been used to provide solutions for a multitude of prediction and inference problems. Many machine learning model architectures, particularly those used for complex tasks (e.g., deep learning models such as neural networks) have a large number of parameters. Further, as task complexity increases (and as desired accuracy increases), the number of parameters used has increased rapidly (e.g., ranging well into the billions in some modern models). This large model size renders training (and, in some cases, inferencing) impractical (and in some cases, impossible) on many devices, particularly resource-constrained systems (e.g., wearables and Internet of Things (IoT) devices).

A variety of approaches have been proposed to mitigate this computational expense. Some such solutions provide techniques for two or more devices jointly train a machine learning model. As one example, one approach involves split training, where each participating device or system trains a portion of the larger model. This reduces computational expense on each system, but results in substantial communication overhead between the systems (e.g., to transmit features and/or gradients between systems for every round of training).

### BRIEF SUMMARY

Certain aspects provide a method, comprising: accessing a first element of input data for a first portion of a neural network; generating, by a first computing system, a first element of output data based on processing the first element of input data using the first portion of the neural network; transmitting, from the first computing system and at a first point in time, the first element of output data to a second computing system for the second computing system to update one or more parameters of a second portion of the neural network based on the first element of output data; determining, by the first computing system at a second point in time subsequent to the first point in time, that one or more communication criteria are not satisfied; and in response to the determining, performing reduced communication training of the neural network, the performing comprising reducing an amount of data transmitted by the first computing system for one or more rounds of training.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example environment for reduced communication split learning, according to various aspects of the present disclosure.

FIG. 2A depicts an example workflow for reduced communication split learning in a full (e.g., uplink and downlink) data state, according to various aspects of the present disclosure.

FIG. 2B depicts an example workflow for reduced communication split learning in a reduced downlink data state, according to various aspects of the present disclosure.

FIG. 2C depicts an example workflow for reduced communication split learning in a reduced uplink state, according to various aspects of the present disclosure.

FIG. 2D depicts an example workflow for reduced communication split learning in a bidirectional reduced state, according to various aspects of the present disclosure.

FIG. 3A depicts an example workflow for reduced communication split learning using dynamic uplink compression, according to various aspects of the present disclosure.

FIG. 3B depicts an example workflow for reduced communication split learning using dynamic downlink compression, according to various aspects of the present disclosure.

FIG. 4 is a flow diagram depicting an example method for reduced communication split learning, according to various aspects of the present disclosure.

FIG. 5 is a flow diagram depicting an example method for performing asynchronous split learning by a client system, according to various aspects of the present disclosure.

FIG. 6 is a flow diagram depicting an example method for performing asynchronous split learning by a server system, according to various aspects of the present disclosure.

FIG. 7 is a flow diagram depicting an example method for reduced communication training of machine learning models, according to various aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for reduced communication and reduced computation training of machine learning models.

In some conventional approaches to split training, the added communication overhead introduced by splitting the model into portions (and allowing each system to train a respective portion) can reduce or even eliminate the benefits of split training. Aspects of the present disclosure provide techniques to dynamically modify the split training procedures to reduce communication and/or computation overhead. This results in improved training processes, as computational and communication expense can be reduced (or at least delayed until later times when such expense has less impact on the other operations of the participating devices).

In some aspects, the reduced communication training can include use of a variety of techniques, including asynchronous training and dynamic compression. As discussed in more detail below, asynchronous communication or training can be used to reduce the number of updates that are exchanged between the participating systems. This substantially reduces the communication overhead, as well as reducing computational load and expense (e.g., by reducing the amount of data each side is expected to process at the given time). Additionally, as discussed in more detail below, dynamic compression can be used to dynamically select an amount of compression to utilize when exchanging data between participating systems. This can substantially reduce the communication overhead while also reducing errors introduced by compression (e.g., as compared to simply compressing all data exchanged). In aspects of the present disclosure, reduced communication training can be performed using asynchronous training, dynamic compression, or a combination of both asynchronous training and dynamic compression, as discussed in more detail below.

In some aspects, dynamic signaling can be used to exchange information between participating devices in order to implement reduced communication protocols (e.g., to indicate whether uplink and/or downlink data should be reduced or paused, to indicate which compression scheme(s) should be used, and the like). This allows for enhanced training of machine learning models that enables additional devices (which may otherwise be unable to participate in the training) to participate, as well as reducing the computational and communication expenses of such participation.

### Example Environment for Reduced Communication Split Learning

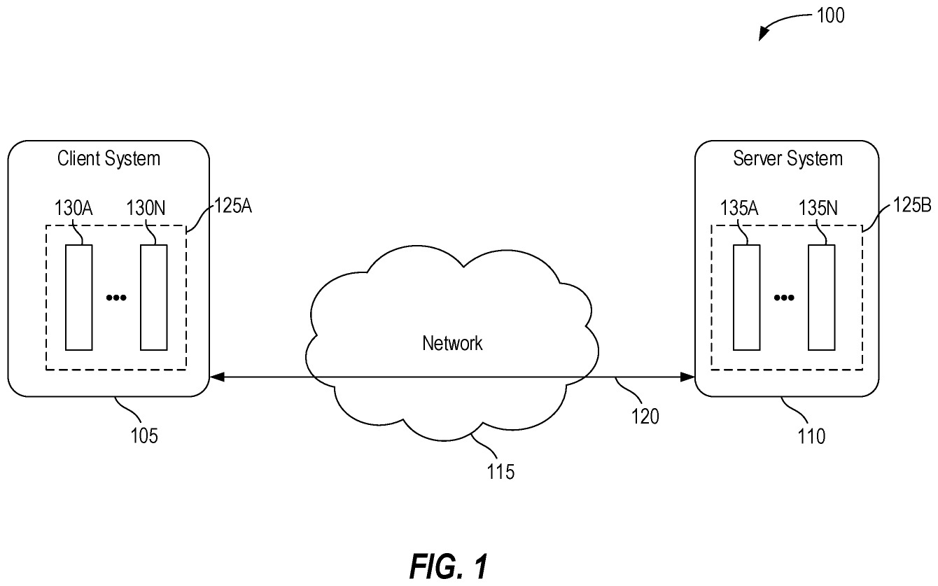

FIG. 1 illustrates an example environment 100 for reduced communication split learning, according to various aspects of the present disclosure.

In the illustrated example, a client system 105 is communicatively coupled with a server system 110 via a link 120 (which may include a network 115). The link 120 is generally representative of any suitable communication systems and techniques. The link 120 may include a combination of wired links and/or wireless links. In some aspects, the network 115 corresponds to the Internet.

Although depicted as discrete systems for conceptual clarity, in aspects, the client system 105 and/or the server system 110 may generally be implemented as standalone computing systems and/or as components as one or more broader systems. For example, the client system 105 may correspond to a machine learning component on a wearable device, while the server system 110 may be implemented as part of a cloud-based deployment. In some aspects, the client system 105 is a relatively more resource-constrained computing system, as compared to the server system 110. Although a single client system 105 and a single server system 110 are depicted for conceptual clarity, in aspects, there may be multiple client systems 105 and/or multiple server systems 110 engaged in the training process.

For example, the client system 105 may correspond to a wearable or IoT device (e.g., having a relatively low clock cycle, small amount of memory, limited storage capacity, limited or no parallel processing capability, limited power or battery capacity, and the like) while the server system 110 may correspond to a relatively more powerful system (e.g., a cluster of servers with high clock cycle, large amounts of memory and storage, high parallel capacity, and the like). In some aspects, the client system 105 and/or server system 110 may be constrained based on a variety of hard and/or soft constraints. For example, hard constraints may refer to hardware limits (e.g., memory size) while soft constraints may refer to dynamic or temporal limits (e.g., resources may be allocated for higher priority tasks at times, leaving a relatively smaller portion of the resources for training). In some aspects, as discussed in more detail below, these and other factors may be evaluated to determine which reduced communication approach(es) should be utilized at any given time to facilitate efficient training operations.

In the illustrated example, the client system 105 and server system 110 are jointly training a machine learning model, where the client system 105 trains a first portion 125A and the server system 110 trains a second portion 125B (collectively, the portions 125) of the machine learning model. In some aspects, the portions 125 may each be referred to as a machine learning model. For example, if the architecture of the model is a neural network, the portions 125A and 125B may be referred to individually as neural networks, as subnets or subnetworks, or as portions of the neural network.

As illustrated, the first portion 125A includes one or more layers 130A-N, while the second portion 125B includes one or more layers 135A-N. In some aspects, the layers 130A-N may be referred to as initial layer(s) to indicate that the layers 130A-N include the start or first layer of the model, but do not include the final layer(s). Similarly, the layers 135A-N may be referred to as final layer(s) to indicate that the layers 135A-N include the last layer of the model, but do not include the first layer. In aspects, the portions 125A and 125B may each include any number of layers (including a single layer), and collectively the portions 125A and 125B form the entire model. For example, the model may be defined as a sequence of layers, and the layers may be delineated into two portions 125, each containing one or more layers, at a partition point (also referred to as a cut point in some aspects). The partition point may be selected using a variety of techniques to balance one or more objectives (e.g., minimizing latency and/or power consumption).

In some aspects, the client system 105 defines the model architecture (e.g., determining values for hyperparameters such as the learning rate, the number of layers, and the like) and selects the partition point (e.g., determining to keep the first M layers in the portion 125A, and relegating the final N layers to the portion 125B). In other aspects, the server system 110 defines this architecture and partition point. In some aspects, the client system 105 and server system 110 may jointly or cooperatively define the architecture and partition point.

In aspects, during training, the client system 105 may process input data using the portion 125A (e.g., using the initial layers 130A-N) of the model to generate a set of features (also referred to as intermediate features or feature tensors) output from an intermediate layer of the model (e.g., the layer 130N). These features are then transmitted to the server system 110, which completes the forward pass by processing the features using the portion 125B (e.g., beginning with the layer 135A) to generate an output from the layer 135N. This output can then be used to train the model (e.g., by generating a loss and backpropagating through the portion 125B. In aspects, the gradients (also referred to as gradient tensors) at the layer 135A are then transmitted to the client system 105, and the client system 105 can continue the backward pass by using the gradients to update the portion 125A.

In this way, for each round of training, features are transmitted from the client system 105 to the server system 110, and gradients are transmitted from the server system 110 to the client system 105. This communication can introduce substantial overhead, particularly as many rounds of such training are often preferred. In the illustrated example, therefore, the client system 105 and the server system 110 may use dynamic reduced communication training techniques to substantially reduce this overhead. For example, as discussed below in more detail, the client system 105 and the server system 110 may selectively exchange data. Some non-limiting examples of selectively exchanging data may include foregoing transmission of features from the client system 105 to the server system 110 for one or more iterations, foregoing transmission of gradients from the server system 110 to the client system 105 for one or more iterations, refraining from exchange both features and gradients for one or more iterations, and/or the like. As another example, as discussed below in more detail, the client system 105 and the server system 110 may dynamically select compression schemes or parameters for each iteration so as to reduce communication and/or computational expense while minimizing (or at least reducing) the error introduced by (lossy) compression techniques.

In some aspects, the participating systems may use one or more finite state machines (FSMs) to determine which state to use. For example, suppose each mode of communication is represented by a state or node in an FSM (e.g., a first state for full data operations, a second state for reduced downlink operations, a third state for reduced uplink operations, and a fourth state for bidirectional reduced operations). Transition criteria may then be defined between each state, allowing the participating systems to move from one state to another (or remain in the current state) based on whether the corresponding transition criteria are satisfied. In some aspects, depending on the particular implementation, the training may operate within a subset of the possible operating states (e.g., switching between a full data state and a reduced downlink state, but not using the reduced uplink state or bidirectional reduced data state).

For example, suppose the training loss at the server system 110 is used as the metric to trigger operational state transitions (e.g., where the difference in the loss between two adjacent training epochs or iterations may be compared to determine whether to transition, where smaller changes in loss may indicate slower training progress). Suppose further that the participating systems desire to continue to update the second portion 125B (e.g., the final portion) of the model frequently or normally, while updating the first portion 125A intermittently or less frequently when training progress is slow. In some aspects, if the change in loss satisfies defined criteria (e.g., meets or exceeds a threshold), the client system 105 and the server system 110 may determine to use the full data state, where features and gradients are exchanged and both portions 125A and 125B are updated. In some aspects, if the change in loss does not satisfy the defined criteria (e.g., is less than the threshold), the client system 105 and the server system 110 may determine to use the reduced downlink data state, where features are transmitted to the server system 110 and the portion 125B is updated, but gradients are not transmitted to the client system 105 and the portion 125A is frozen.

As another example, suppose the channel condition between the client system 105 and the server system 110 is used as the metric to trigger operational state transitions (e.g., measured by data rate). Suppose further that the participating systems desire to continue to train both of the portions 125A and 125B when the data rate is sufficiently high, and to refrain from exchanging data when the data rate is lower. In some aspects, if the data rate satisfies defined criteria (e.g., meets or exceeds a threshold), the client system 105 and the server system 110 may determine to use the full data state, where features and gradients are exchanged and both portions 125A and 125B are updated. In some aspects, if the data rate does not satisfy the defined criteria (e.g., is less than the threshold), the client system 105 and the server system 110 may determine to use a different state, such as the bidirectional reduced data state, where features are not transmitted to the server system 110 and gradients are not transmitted to the client system 105. In some aspects, the server system 110 may pause updating of the portion 125B. In other aspects, the server system 110 may continue to train the portion 125B based on one or more previously received features (as discussed below in more detail).

As another example, suppose the characteristics of the training data available on the client system 105 are used as the metric to trigger operational state transitions (e.g., the signal-to-noise (SNR) ratio of the available data in the current iteration, the number of samples available, and/or the distribution of samples available). Suppose further that the participating systems desire to continue to train both of the portions 125A and 125B when the training data characteristics meets the criteria, and to refrain from exchanging data when the characteristics do not meet the criteria. In some aspects, if the characteristics satisfy defined criteria (e.g., meets or exceeds a threshold), the client system 105 and the server system 110 may determine to use the full data state, where features and gradients are exchanged and both portions 125A and 125B are updated. In some aspects, if the characteristics do not satisfy the defined criteria (e.g., is less than the threshold), the client system 105 and the server system 110 may determine to use a different state, such as the bidirectional reduced data state, where features are not transmitted to the server system 110 and gradients are not transmitted to the client system 105. In some aspects, the server system 110 may pause updating of the portion 125B. In other aspects, the server system 110 may continue to train the portion 125B based on one or more previously received features (as discussed below in more detail).

In some aspects, as discussed above, the client system 105 and server system 110 may similarly use FSMs and transition criteria to determine which compression technique(s) to use in any given iteration.

In these ways, using aspects of the present disclosure, the reduced communication training techniques described herein can substantially reduce the expense incurred by training the model, allowing an increased variety of client systems 105 and server systems 110 to participate, as well as enabling training of larger and more complex models, and reducing the bandwidth consumed by such training.

### Example Workflows for Reduced Communication Split Learning

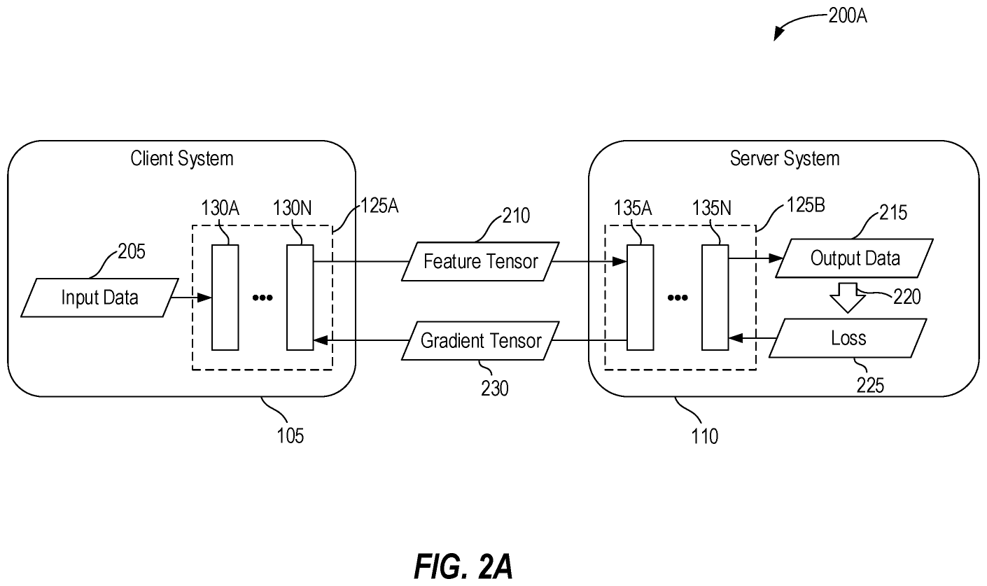

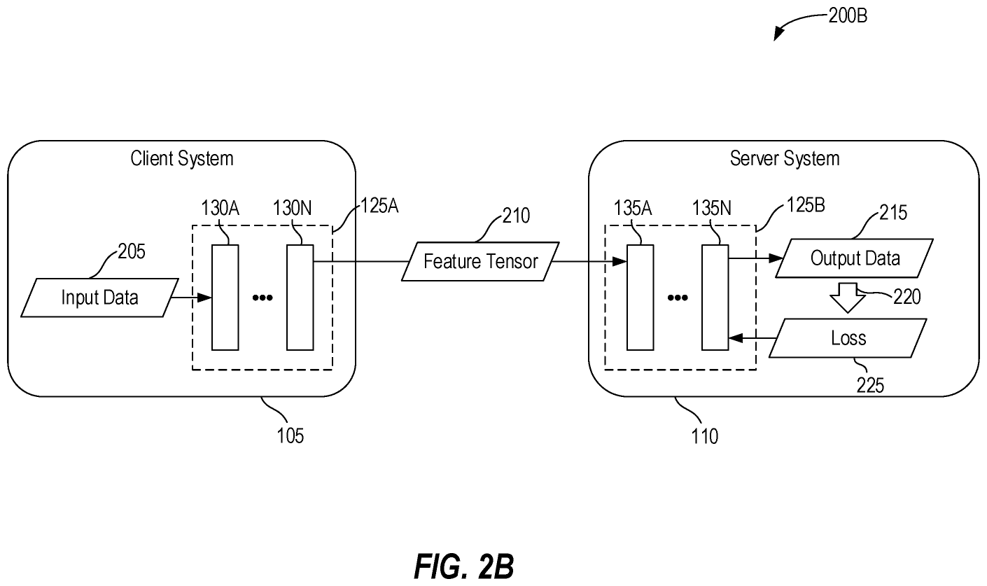

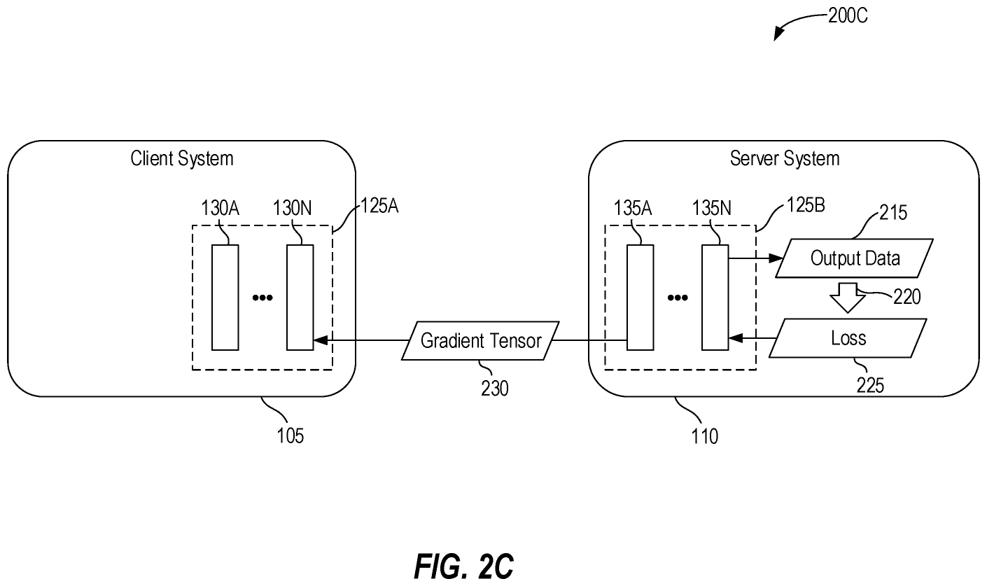

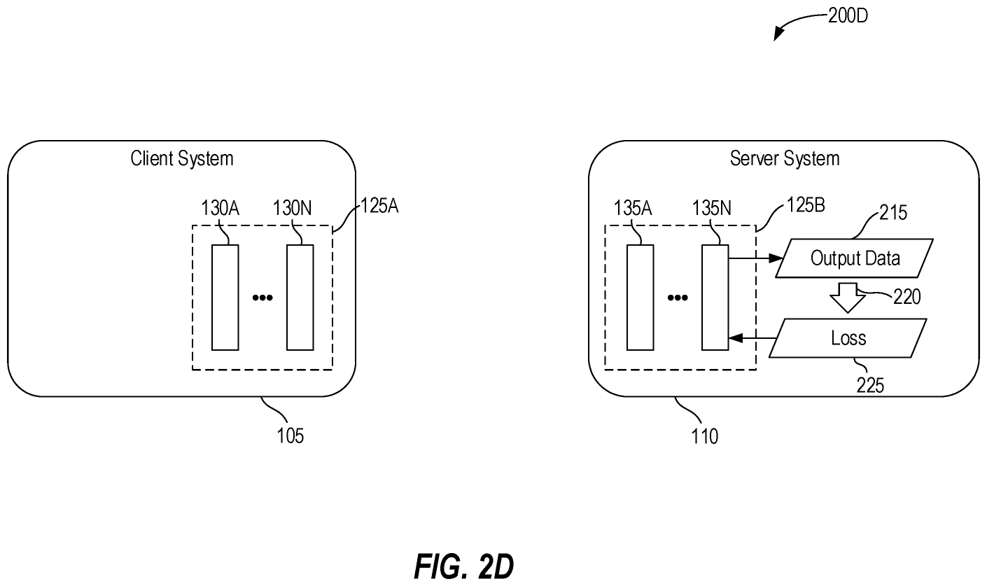

FIGS. 2A-2D depict example workflows for reduced communication split learning, according to various aspects of the present disclosure. Specifically, each of FIGS. 2A-2D depict a different reduced communication state that can be used to reduce the communication and computation overhead of split training for machine learning models. In some aspects, the participating systems can dynamically move between these states (e.g., switching between the workflows depicted in FIGS. 2A-2D) based on a wide variety of criteria. In some aspects, any participating system may initiate a transfer to a different operating state. In some aspects, the participating systems negotiate or agree upon an operating state at the start of each iteration, as discussed in more detail below.

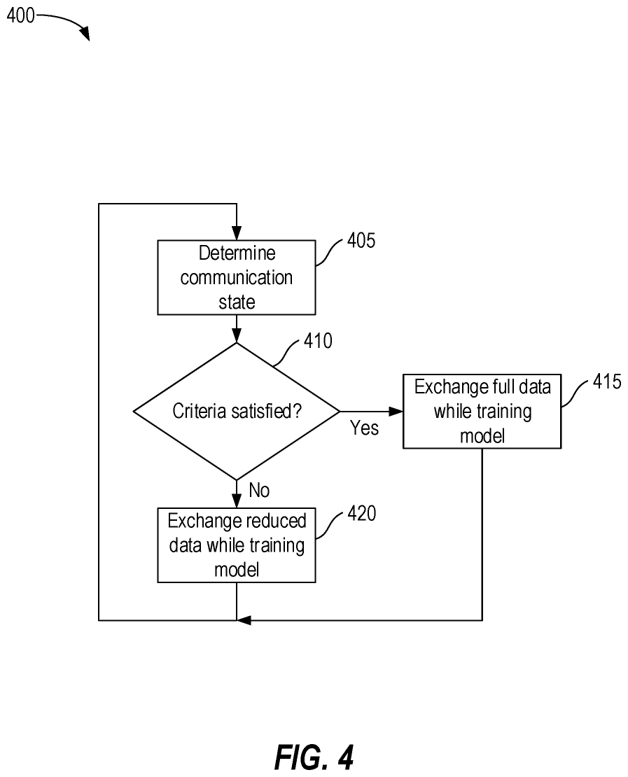

The criteria or factors used to determine whether to switch to a new state may vary depending on the particular implementation. By way of example and not limitation, the participating system(s) may consider or evaluate the state of one or more communication links between the participating computing systems (e.g., the current data rate, the stability or uptime of the connection, the transmit retry rate, and the like), the resource availability on both or either participating systems (e.g., whether any of the systems are currently handling other higher priority operations, leaving few or no resources available for training), indication(s) of training progress for the model (e.g., comparing the current loss magnitude to the prior loss magnitude to determine whether training is progressing, where the systems may determine to move to a different state if the change in loss magnitude is less than or greater than one or more thresholds), characteristic(s) of training data being used to train the model (e.g., whether there is sufficient data for another round of training, whether the signal-to-noise (SNR) ratio of the current batch of training data meets designated criteria, whether the distribution of the current batch meets designated criteria, and the like), and the like. Some example evaluations of criteria to dynamically switch between training modes or states are discussed in more detail below with reference to FIG. 4.

FIG. 2A depicts an example workflow 200A for reduced communication split learning in a full data state, according to various aspects of the present disclosure.

In the illustrated example, the “full data” state may refer to an operational or training state where the client system 105 and the server system 110 exchange full training data (e.g., for each sample of training data, the client system 105 transmits features to the server system 110, and the server system 110 transmits gradients to the client system 105). Specifically, as illustrated, the client system 105 processes input data 205 using the portion 125A of the model (e.g., using the initial layers 130A-N) to generate a feature tensor 210. As discussed above, this feature tensor 210 generally corresponds to the intermediate features output by an internal or hidden layer of the network (e.g., by layer 130N).

As illustrated, during the “full data” operations, the client system 105 transmits the feature tensor 210 to the server system 110. The server system 110 processes the received feature tensor 210 using the portion 125B of the model (e.g., the final layers 135A-N) to generate output data 215. The particular content and format of the output data 215 may vary depending on the particular implementation and task. For example, in a classification task, the output data 215 may comprise a predicted classification (e.g., probability or confidence of one or more classifications) of the input data 205. For a regression task, the output data 215 may include a predicted value (e.g., a continuous numerical value) for the input data 205.

In the illustrated example, as depicted by operation 220, the server system 110 can then evaluate the output data 215 to generate a loss 225. For example, if a ground-truth value is available for the input data 205 (e.g., if the server system 110 already knows the ground truth, such as if client system 105 indicates the ground truth for the input data 205), the server system 110 may compare the output data 215 to this ground truth using a variety of loss formulations (e.g., cross entropy) to generate the loss 225.

In some aspects, to preserve privacy, the server system 110 may alternatively transmit the output data 215 to the client system 105 (or to another system having the ground truth label). In such aspects, the client system 105 (or other system) may compare the output data 215 to the ground truth to generate the loss 225, and the client system 105 (or other system) may thereafter transmit the loss 225 back to the server system 110.

As illustrated, the server system 110 then uses the loss 225 to refine the portion 125B. That is, the server system 110 may update one or more parameters of the portion 125B (e.g., weights of the layers 135A-N), such as by using backpropagation. In some aspects, the updating of the portion 125B includes generating gradients at each layer 135 of the portion 125B and using these gradients to update the parameters of the layer 135 (as well as to generate gradients for each prior layer), moving from the final layer of the model (e.g., the layer 135N) through the first layer of the portion 125B (e.g., the layer 135A).

As illustrated, in the full data workflow 200A, the server system 110 then transmits the gradient tensor 230 from the layer 135A to the client system 105. The client system 105 uses this received gradient tensor 230 to update the portion 125A (e.g., to update one or more parameters of the layers 130A-N). For example, as discussed above with reference to updating the portion 125B, the client system 105 may backpropagate the gradient tensor 230 through the portion 125A (e.g., beginning with the layer 130N and moving through the layer 130A). In this way, the client system 105 trains the portion 125A based on the input data 205 and label, while the server system 110 trains the portion 125B based on the input data 205 and label.

In some aspects, this process can be repeated any number of times. For example, the client system 105 may generate any number of feature tensors 210 based on any number of samples of input data 205, transmitting each feature tensor 210 (or an aggregated representation of the feature tensors) to the server system 110. Generally, the depicted systems may use stochastic gradient descent (e.g., generating a separate loss 225 for each respective input data 205) or batch gradient descent (e.g., generating an aggregated loss based on a batch of input samples) to train the model.

In some aspects, the client system 105 and server system 110 can use the full data workflow 200A for one or more iterations or epochs. For example, the client system 105 and/or server system 110 may periodically re-evaluate the communication criteria (e.g., at the end of each iteration and/or epoch, after every N training samples, iterations, or epochs, and the like) to determine whether to stay in the full data state (e.g., to continue using the workflow 200A to exchange feature tensors 210 and gradient tensors 230) or to transition to another communication state (e.g., one of the states discussed below with reference to the workflows 200B, 200C, and 200D of FIGS. 2B, 2C, and 2D).

In some aspects, at defined intervals (e.g., at the start of each iteration or epoch), the client system 105 and server system 110 may negotiate or indicate which state to use. For example, each system may evaluate the various communication criteria to determine which state to use. The client system 105 and the server system 110 may then exchange management or control frames to determine which state should be used (e.g., by selecting the state with the minimum exchange of data, as discussed below in more detail). For example, if one system determines to use a full data state while the other determines to use a reduced data state, the systems may agree to use the reduced data state, as discussed below in more detail. As another example, if one system selects one type of reduced data state while the other selects a different type of reduced data state, the systems may agree to use one of the selected states (or a third, as yet unselected state) using any suitable selection criteria.

FIG. 2B depicts an example workflow 200B for reduced communication split learning in a reduced downlink data state, according to various aspects of the present disclosure.

In the illustrated example, the “reduced downlink” state may refer to an operational or training state where the client system 105 transmits feature data to the server system 110, but the server system 110 does not transmit full gradient data to the client system 105. Specifically, as illustrated, the client system 105 processes input data 205 using the portion 125A of the model (e.g., using the initial layers 130A-N) to generate a feature tensor 210. As discussed above, this feature tensor 210 generally corresponds to the intermediate features output by an internal or hidden layer of the network (e.g., by layer 130N).

As illustrated, during the “reduced downlink” operations, the client system 105 transmits the feature tensor 210 to the server system 110. The server system 110 processes the received feature tensor 210 using the portion 125B of the model (e.g., the final layers 135A-N) to generate output data 215. As discussed above, the particular content and format of the output data 215 may vary depending on the particular implementation and task. For example, in a classification task, the output data 215 may comprise a predicted classification (e.g., a probability or confidence of one or more classifications) of the input data 205. For a regression task, the output data 215 may include a predicted value (e.g., a continuous numerical value) for the input data 205.

As depicted by operation 220, the server system 110 can then evaluate the output data 215 to generate a loss 225, as discussed above. For example, if a ground-truth value is available for the input data 205 (e.g., if the server system 110 already knows the ground truth, such as if client system 105 indicates the ground truth for the input data 205), the server system 110 may compare the output data 215 to this ground truth using a variety of loss formulations (e.g., cross entropy) to generate the loss 225.

In some aspects, to preserve privacy, the server system 110 may alternatively transmit the output data 215 to the client system 105 (or to another system having the ground truth label). In such aspects, the client system 105 (or other system) may compare the output data 215 to the ground truth to generate the loss 225, and the client system 105 (or other system) may thereafter transmit the loss 225 back to the server system 110.

As illustrated, the server system 110 then uses the loss 225 to refine the portion 125B. That is, the server system 110 may update one or more parameters of the portion 125B (e.g., weights of the layers 135A-N), such as by using backpropagation. In some aspects, the updating of the portion 125B includes generating gradients at each layer 135 of the portion 125B and using these gradients to update the parameters of the layer 135 (as well as to generate gradients for each prior layer), moving from the final layer of the model (e.g., the layer 135N) through the first layer of the portion 125B (e.g., the layer 135A).

In the illustrated reduced downlink workflow 200B, the server system 110 refrains from transmitting a gradient tensor to the client system 105. That is, because the client system 105 and/or server system 110 have determined to operate in a reduced downlink communication state, the server system 110 may refrain from transmitting gradients to the client system 105, even though the client system 105 continues to transmit feature tensors 210 to the server system 110. In this way, the portion 125A is effectively frozen during the workflow 200B, though the portion 125B continues to be updated. That is, the parameters of the portion 125A are unchanged during the depicted workflow 200B, and the server system 110 continues to update parameters of the portion 125B.

Although the illustrated example depicts the server system 110 refraining from transmitting any gradients to the client system 105, in some aspects, the server system 110 may alternatively transmit compressed or reduced sets of gradients to the client system 105 during the reduced downlink workflow 200B. For example, the server system 110 may compress the gradient tensor(s) using one or more compression operations, as discussed in more detail below, prior to transmitting the gradient tensor(s) to the client system 105. This may allow the client system 105 to continue to update the portion 125A (albeit, potentially with less accurate gradients caused by losses in the compression), while still substantially reducing the communication overhead of the training process. As another example, the server system 110 may transmit a subset of the gradients (e.g., returning a gradient tensor for every N feature tensors 210 received), thereby enabling at least some updating of the portion 125A with reduced communication overhead.

In aspects, the reduced downlink data state generally corresponds to periods when the client system 105 transmits full data (e.g., uncompressed feature tensors 210, or feature tensors 210 compressed using lossless algorithms) to the server system 110, while the server system 110 either refrains from transmitting gradients to the client system 105, or transmits a reduced version (e.g., every other gradient tensor, or gradient tensors compressed using one or more lossy compression algorithms).

In some aspects, this process can be repeated any number of times. For example, the client system 105 may generate any number of feature tensors 210 based on any number of samples of input data 205, transmitting each feature tensor 210 (or an aggregated representation of the feature tensors) to the server system 110. Generally, the depicted systems may use stochastic gradient descent (e.g., generating a separate loss 225 for each respective input data 205) or batch gradient descent (e.g., generating an aggregated loss based on a batch of input samples) to train the model.

In some aspects, the client system 105 and server system 110 can use the reduced downlink workflow 200B for one or more iterations or epochs, as discussed above. For example, the client system 105 and/or server system 110 may periodically re-evaluate the communication criteria (e.g., at the end of each iteration and/or epoch, after every N training samples, iterations, or epochs, and the like) to determine whether to stay in the reduced downlink state (e.g., to continue using the workflow 200B to exchange reduced data) or to transition to another communication state (e.g., the full data state discussed above with reference to the workflow 200A of FIG. 2A, or one of the states discussed below with reference to the workflows 200C and 200D of FIGS. 2C and 2D).

For example, as discussed above, each system may evaluate the various communication criteria to determine which state to use. The client system 105 and the server system 110 may then exchange management or control frames to determine which state should be used (e.g., by selecting the state with the minimum exchange of data, as discussed below in more detail). For example, if one system determines to remain in the reduced downlink state while the other determines to transition to the full data state, the systems may agree to use the reduced downlink state. As another example, if one system selects one type of reduced data state while the other selects a different type of reduced data state, the systems may agree to use one of the selected states (or a third, as yet unselected state) using any suitable selection criteria.

FIG. 2C depicts an example workflow 200C for reduced communication split learning in a reduced uplink state, according to various aspects of the present disclosure.

In the illustrated example, the “reduced uplink” state may refer to an operational or training state where the client system 105 refrains from transmitting feature data to the server system 110, but the server system 110 transmits gradient data to the client system 105. Specifically, as illustrated, the client system 105 may or may not process input data using the portion 125A of the model (e.g., using the initial layers 130A-N) to generate feature tensors. The server system 110, however, continues to transmit gradient tensors 230 to the client system 105.

As illustrated, during the “reduced uplink” operations, the server system 110 may process one or more previously received feature tensors using the portion 125B of the model (e.g., the final layers 135A-N) to generate output data 215. As discussed above, the particular content and format of the output data 215 may vary depending on the particular implementation and task. For example, in a classification task, the output data 215 may comprise a predicted classification (e.g., a probability or confidence of one or more classifications) of the input data 205. For a regression task, the output data 215 may include a predicted value (e.g., a continuous numerical value) for the input data 205.

That is, although new feature tensors are not received by the server system 110 during the depicted workflow 200C, the server system 110 may re-process feature tensors that were previously received from the client system 105 (e.g., during a prior full data state or reduced downlink state), which the server system 110 may have stored for subsequent use. This can allow the server system 110 to re-use this prior data to continue training the portion 125B, even when no additional feature tensors are received during the workflow 200C.

As depicted by operation 220, the server system 110 (or another system) can then evaluate the output data 215 to generate a loss 225, as discussed above. As illustrated, the server system 110 then uses the loss 225 to refine the portion 125B. That is, the server system 110 may update one or more parameters of the portion 125B (e.g., weights of the layers 135A-N), such as by using backpropagation. In some aspects, the updating of the portion 125B includes generating gradients at each layer 135 of the portion 125B and using these gradients to update the parameters of the layer 135 (as well as to generate gradients for each prior layer), moving from the final layer of the model (e.g., the layer 135N) through the first layer of the portion 125B (e.g., the layer 135A).

In the illustrated reduced uplink workflow 200C, the server system 110 then transmits the gradient tensor 230 to the client system 105. The client system 105 may use this received gradient tensor 230 to update the portion 125A (e.g., to update one or more parameters of the layers 130A-N). For example, as discussed above, the client system 105 may backpropagate the gradient tensor 230 through the portion 125A (e.g., beginning with the layer 130N and moving through the layer 130A). In this way, the client system 105 trains the portion 125A based on previously generated feature tensors.

In some aspects, by refraining from generating and/or transmitting new feature tensors to the server system 110, the client system 105 can substantially reduce its workload (e.g., because new feature tensors need not be generated) as well as the communication overhead of the training process (e.g., because new feature tensors need not be transmitted to the server system 110).

Although the illustrated example depicts the client system 105 refraining from transmitting any features to the server system 110, in some aspects, the client system 105 may alternatively transmit compressed or reduced sets of features to the server system 110 during the reduced uplink workflow 200C. For example, the client system 105 may compress the feature tensor(s) using one or more compression operations, as discussed in more detail below, prior to transmitting the feature tensor(s) to the server system 110. This may allow the server system 110 to continue to use new features to update the portion 125B (albeit, potentially with less accurate features caused by losses in the compression), while still substantially reducing the communication overhead of the training process. As another example, the client system 105 may transmit a subset of the features (e.g., transmitting fewer feature tensors), thereby enabling at least some new training with reduced communication overhead.

In aspects, the reduced uplink data state generally corresponds to periods when the server system 110 transmits full data (e.g., uncompressed gradient tensors 230, or gradient tensors 230 compressed using lossless algorithms) to the client system 105, while the client system 105 either refrains from transmitting features to the server system 110, or transmits a reduced version (e.g., feature tensors compressed using one or more lossy compression algorithms).

In some aspects, this process can be repeated any number of times. For example, the server system 110 may generate any number of gradient tensors 230 based on any number of previously received and stored feature tensors, transmitting each gradient tensor 230 (or an aggregated representation of the gradient tensors) to the client system 105. Generally, the depicted systems may use stochastic gradient descent (e.g., generating a separate loss 225 for each respective feature tensor) or batch gradient descent (e.g., generating an aggregated loss based on a batch of input samples) to train the model.

In some aspects, the client system 105 and server system 110 can use the reduced uplink workflow 200C for one or more iterations or epochs, as discussed above. For example, the client system 105 and/or server system 110 may periodically re-evaluate the communication criteria (e.g., at the end of each iteration and/or epoch, after every N training samples, iterations, or epochs, and the like) to determine whether to stay in the reduced uplink state (e.g., to continue using the workflow 200C to exchange reduced data) or to transition to another communication state (e.g., the full data state discussed above with reference to the workflow 200A of FIG. 2A, the reduced downlink state discussed above with reference to the workflow 200B of FIG. 2B, or to the workflow 200D of FIG. 2D).

FIG. 2D depicts an example workflow 200D for reduced communication split learning in a bidirectional reduced state, according to various aspects of the present disclosure.

In the illustrated example, the “bidirectional reduced” state may refer to an operational or training state where the client system 105 refrains from transmitting feature data to the server system 110, and the server system 110 similarly refrains from transmitting gradient data to the client system 105. Specifically, as illustrated, the client system 105 may or may not process input data using the portion 125A of the model (e.g., using the initial layers 130A-N) to generate feature tensors.

As illustrated, during the “bidirectional reduced” operations, the server system 110 may process one or more previously received feature tensors using the portion 125B of the model (e.g., the final layers 135A-N) to generate output data 215. As discussed above, the particular content and format of the output data 215 may vary depending on the particular implementation and task. For example, in a classification task, the output data 215 may comprise a predicted classification of the input data 205. For a regression task, the output data 215 may include a predicted value (e.g., a continuous numerical value) for the input data 205.

That is, although new feature tensors are not received by the server system 110 during the depicted workflow 200D, the server system 110 may re-process feature tensors that were previously received from the client system 105 (e.g., during a prior full data state or reduced downlink state), which the server system 110 may have stored for subsequent use. This can allow the server system 110 to re-use this prior data to continue training the portion 125B, even when no additional feature tensors are received during the workflow 200D.

As depicted by operation 220, the server system 110 (or another system) can then evaluate the output data 215 to generate a loss 225, as discussed above. As illustrated, the server system 110 then uses the loss 225 to refine the portion 125B. That is, the server system 110 may update one or more parameters of the portion 125B (e.g., weights of the layers 135A-N), such as by using backpropagation. In some aspects, the updating of the portion 125B includes generating gradients at each layer 135 of the portion 125B and using these gradients to update the parameters of the layer 135 (as well as to generate gradients for each prior layer), moving from the final layer of the model (e.g., the layer 135N) through the first layer of the portion 125B (e.g., the layer 135A).

In the illustrated bidirectional reduced data workflow 200D, the server system 110 refrains from transmitting gradient tensors to the client system 105. That is, because the client system 105 and/or server system 110 have determined to operate in a reduced communication state (e.g., the bidirectional reduced state), the server system 110 may refrain from transmitting gradients to the client system 105. In this way, the portion 125A is effectively frozen during the workflow 200D, though the portion 125B may continue to be updated based on prior received features. That is, the parameters of the portion 125A are unchanged during the depicted workflow 200D, and the server system 110 continues to update parameters of the portion 125B.

In some aspects, by refraining from generating and/or transmitting new feature tensors to the server system 110, the client system 105 can substantially reduce its workload (e.g., because new feature tensors need not be generated) as well as the communication overhead of the training process (e.g., because new feature tensors need not be transmitted to the server system 110). Similarly, by refraining from transmitting new gradient tensors to the client system 105, the server system 110 can substantially reduce the communication overhead of the training process.

Although the illustrated example depicts the client system 105 and the server system 110 refraining from transmitting any features or gradients, in some aspects, the client system 105 and/or the server system 110 may alternatively transmit compressed or reduced sets of data to the other system during the workflow 200D. For example, the client system 105 and/or server system 110 may compress the feature tensor(s) and/or gradient tensors, respectively, using one or more compression operations, as discussed in more detail below, prior to transmitting the tensor(s). This may allow the systems to continue to use new features and gradients to update the model (albeit, potentially with less accurate results caused by losses in the compression), while still substantially reducing the communication overhead of the training process.

In aspects, the bidirectional reduced state generally corresponds to periods when neither the server system 110 nor the client system 105 transmits full data (e.g., uncompressed data, or data compressed using lossless algorithms) to the other system. Instead, both the client system 105 and the server system 110 either refrain from transmitting data to the other system, or transmit reduced versions (e.g., tensors compressed using one or more lossy compression algorithms).

In some aspects, this process can be repeated any number of times. For example, the server system 110 may generate any number of losses 225 based on any number of previously received and stored feature tensors, updating the portion 125B any number of times.

In some aspects, the client system 105 and server system 110 can use the bidirectional reduced workflow 200D for one or more iterations or epochs, as discussed above. For example, the client system 105 and/or server system 110 may periodically re-evaluate the communication criteria (e.g., at the end of each iteration and/or epoch, after every N training samples, iterations, or epochs, and the like) to determine whether to stay in the bidirectional reduced state (e.g., to continue using the workflow 200D) or to transition to another communication state (e.g., the full data state discussed above with reference to the workflow 200A of FIG. 2A, the reduced downlink state discussed above with reference to the workflow 200B of FIG. 2B, or to the reduced uplink state discussed above with reference to the workflow 200C of FIG. 2C).

In some aspects, the full data state depicted and discussed above with reference to FIG. 2A may be referred to as a first state, a first communication state, a first training state, a first computation state, and the like. Each other training state (such as the reduced downlink state discussed above with reference to FIG. 2B, the reduced uplink state discussed above with reference to FIG. 2C, and/or the bidirectional reduced state discussed above with reference to FIG. 2D) may similarly be referred to as a second state, a second communication state, a second training state, a second computation state, and the like. Similarly, each other state may be referred to as a third state, a fourth state, and so on.

### Example Workflows for Reduced Communication Split Learning Using Dynamic Compression

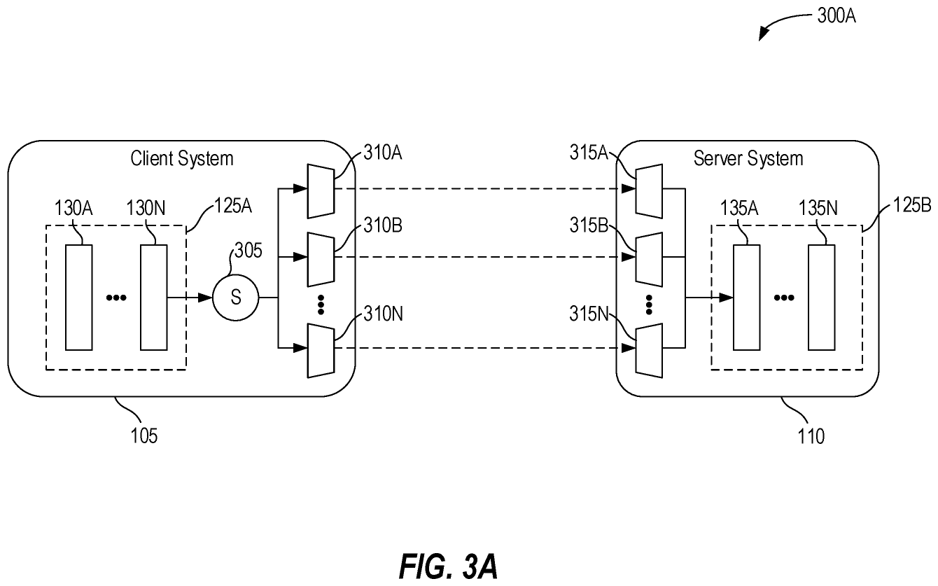

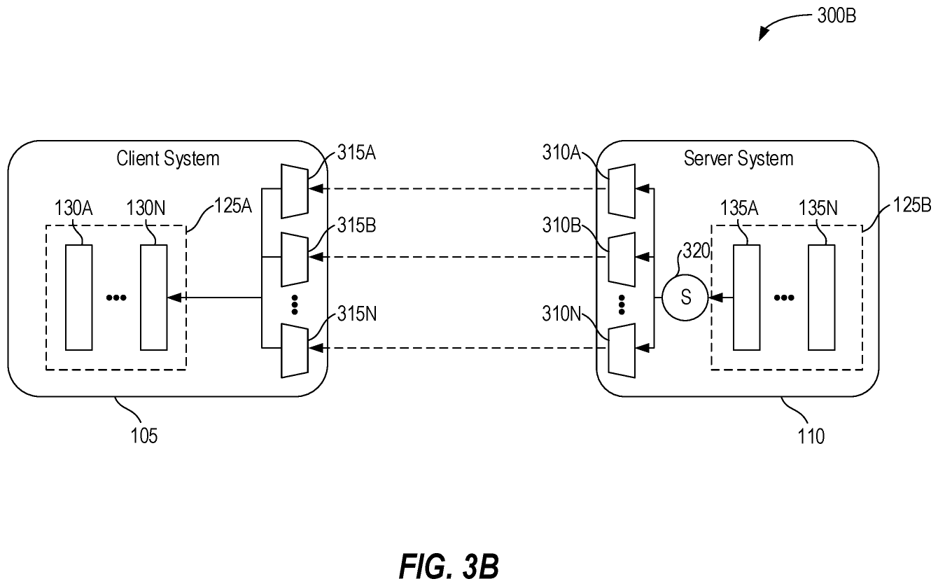

FIG. 3A depicts an example workflow 300A for reduced communication split learning using dynamic uplink compression, according to various aspects of the present disclosure.

In some aspects, the workflow 300A may be used during any communication or training state when the uplink data is reduced or eliminated. For example, the workflow 300A may be used to transmit compressed or reduced uplink data (from the client system 105 to the server system 110) during the reduced uplink state discussed above with reference to the workflow 200C of FIG. 2C and/or the bidirectional reduced data state discussed above with reference to the workflow 200D of FIG. 2D. That is, although the reduced uplink state and reduced bidirectional states discussed above with reference to FIGS. 2C and 2D do not depict the client system 105 transmitting feature tensors, in some aspects, the workflow 300A may additionally or alternatively be used to transmit a relatively reduced amount of data (e.g., compressed feature tensors, as compared to full-precision or non-compressed feature tensors in the full data state) from the client system 105 to the server system 110, substantially reducing the amount of uplink data overhead, while still continuing the training process.

In the illustrated example, as discussed above, the client system 105 may process input data using the portion 125A of the model (e.g., using the initial layers 130A-N) to generate a feature tensor (depicted in FIG. 2A but not depicted in FIG. 2C or 2D). As discussed above, this feature tensor generally corresponds to the intermediate features output by an internal or hidden layer of the network (e.g., by layer 130N).

As illustrated, during the workflow 300A, the client system 105 may select one or more compression operations to use before transmitting the feature data to the server system 110. Specifically, as illustrated by switch 305, the client system 105 may select a compression operation 310A-N (collectively, the compression operations 310). In some aspects, the compression operations 310 each have a different compression rate and/or a different level of lossiness. For example, the compression operation 310A may compress data with a relatively small compression rate (e.g., where the compressed data is only slightly smaller than the original data), but with a relatively small amount of loss (e.g., a relatively small amount of error or noise introduced). The compression operation 310B may have a higher compression rate than the compression operation 310A (resulting in smaller compressed data), while introducing a relatively larger amount of decompression or reconstruction error or noise. Further, the compression operation 310N may have an even higher compression rate (e.g., resulting in substantially reduced size of the compressed data), while introducing an even larger amount of decompression or reconstruction error or noise. Although three compression operations 310 are depicted, the client system 105 may use any number of compression operations.

Generally, the particular configuration of the compression operations 310 may vary depending on the particular implementation. For example, in some aspects, one or more of the compression operations 310 may correspond to autoencoders. As used herein, an autoencoder is a type of unsupervised artificial neural network that has been trained (alongside an autodecoder) to generate an efficient data representation of input data. The encoder portion generally learns to map input vectors (e.g., feature tensors) to a latent vector space, often at a reduced size in comparison to the input. As discussed below in more detail, the decoder portion (represented by decompression operations 315A-N) generally learns to map this latent vector to a reconstructed version of the input (e.g., to a reconstruction of the original feature tensor). Transmitting the latent tensor, rather than transmitting the full feature tensor generated by the client system 105, can eliminate a significant amount of data traffic during split learning.

In some aspects, the client system 105 selects which compression operation 310 to use for a given state or feature tensor. That is, based on the communication criteria (e.g., based on congestion or channel state in the communication network(s) connecting the systems), the client system 105 may select one of the compression operations 310A-N to balance the compression rate with the reconstruction error. For example, when channel congestion is high, the client system 105 may select a compression operation 310 with a high compression rate (even with a high reconstruction error). When channel congestion is relatively lower, the client system 105 may select a compression operation 310 with a relatively lower compress rate (resulting in a relatively lower reconstruction error).

As illustrated, the client system 105 then transmits these compressed features to the server system 110. In the illustrated example, the server system 110 then decompresses the received data using the corresponding decompression operation 315 to reconstruct the original feature tensor, and the server system 110 processes the decompressed data using the portion 125B of the model (e.g., the final layers 135A-N) to generate output data. The server system 110 can then evaluate the output data to generate a loss, as discussed above, and use the loss to update one or more parameters of the portion 125B (e.g., weights of the layers 135A-N), such as by using backpropagation.

In some aspects, as discussed above, the client system 105 and the server system 110 may negotiate or indicate which compression operation will be used. For example, at defined intervals (e.g., at the start of each iteration or epoch), one of or each system may evaluate the various communication criteria to determine which pair of compression operation 310 and decompression operation 315 to use. The client system 105 and the server system 110 may then exchange management or control frames to determine which compression alternative should be used (e.g., by selecting the operation with the minimum exchange of data). For example, if one system determines to use the compression operation 310A and decompression operation 315A (e.g., with minimal introduced error) while the other determines to use the compression operation 310N and decompression operation 315N (e.g., with higher compression rate but also higher error), the systems may agree to use the compression operation 310N. As another example, if one system selects the compression operation 310A and decompression operation 315A while the other determines to use no compression, the systems may agree to use the compression operation 310A and decompression operation 315A.

FIG. 3B depicts an example workflow 300B for reduced communication split learning using dynamic downlink compression, according to various aspects of the present disclosure.

In some aspects, the workflow 300B may be used during any communication or training state when the downlink data is reduced or eliminated. For example, the workflow 300B may be used to transmit compressed or reduced downlink data (from the server system 110 to the client system 105) during the reduced downlink state discussed above with reference to the workflow 200B of FIG. 2B and/or the bidirectional reduced data state discussed above with reference to the workflow 200D of FIG. 2D. That is, although the reduced downlink state and reduced bidirectional states discussed above with reference to FIGS. 2B and 2D do not depict the server system 110 transmitting gradient tensors, in some aspects, the workflow 300B may additionally or alternatively be used to transmit a relatively reduced amount of data (e.g., compressed gradient tensors, as compared to full-precision or non-compressed gradient tensors in the full data state) from the server system 110 to the client system 105, substantially reducing the amount of downlink data overhead, while still continuing the training process.

In the illustrated example, as discussed above, the server system 110 may process feature data (either newly received, or previously received and stored) using the portion 125B of the model (e.g., using the final layers 135A-N) to generate an output of the model. As discussed above, this output generally comprises a prediction for the corresponding input. The server system 110 may then use this output to generate a loss, as discussed above, which can be used to update the parameters of the portion 125B (e.g. using backpropagation). As discussed above, this updating procedure results in a gradient tensor from the layer 135N (depicted in FIG. 2A but not depicted in FIG. 2B or 2D), which may be provided to the client system 105.

As illustrated, during the workflow 300B, the server system 110 may select one or more compression operations to use before transmitting the gradient data to the client system 105. Specifically, as illustrated by the switch 320, the server system 110 may select a compression operation 310A-N (collectively, the compression operations 310). In some aspects, as discussed above, the compression operations 310 each have a different compression rate, as well as a different reconstruction error. Although three compression operations 310 are depicted, the server system 110 may use any number of compression operations. Generally, the particular configuration of the compression operations 310 may vary depending on the particular implementation. For example, as discussed above, one or more of the compression operations 310 may correspond to autoencoders.

In some aspects, the server system 110 selects which compression operation 310 to use for a given state or gradient tensor. That is, based on the communication criteria (e.g., based on congestion or channel state in the communication network(s) connecting the systems), the server system 110 may select one of the compression operations 310A-N to balance the compression rate with the reconstruction error. For example, when channel congestion is high, the server system 110 may select a compression operation 310 with a high compression rate (even with a high reconstruction error). When channel congestion is relatively lower, the server system 110 may select a compression operation 310 with a relatively lower compress rate (resulting in a relatively lower reconstruction error).

As illustrated, the server system 110 then transmits these compressed gradients to the client system 105. In the illustrated example, the client system 105 then decompresses the received data using the corresponding decompression operation 315 to reconstruct the original feature tensor as discussed above. The client system 105 can then process the decompressed data to update the parameters of the portion 125A of the model (e.g., the initial layers 130A-N), such as by using backpropagation.

In some aspects, as discussed above, the client system 105 and the server system 110 may negotiate or indicate which compression operation will be used for the gradients. For example, at defined intervals (e.g., at the start of each iteration or epoch), each system may evaluate the various communication criteria to determine which pair of compression operation 310 and decompression operation 315 to use. The client system 105 and the server system 110 may then exchange management or control frames to determine which compression alternative should be used (e.g., by selecting the operation with the minimum exchange of data). For example, if one system determines to use the compression operation 310A and decompression operation 315A (e.g., with minimal introduced error) while the other determines to use the compression operation 310N and decompression operation 315N (e.g., with higher compression rate but also higher error), the systems may agree to use the compression operation 310N. As another example, if one system selects the compression operation 310A and decompression operation 315A while the other determines to use no compression, the systems may agree to use the compression operation 310A and decompression operation 315A

### Example Method for Reduced Communication Split Learning

FIG. 4 is a flow diagram depicting an example method 400 for reduced communication split learning, according to various aspects of the present disclosure. In some aspects, the method 400 is performed by a client system participating in split training of a machine learning model, such as the client system 105 of FIG. 1. In some aspects, the method 400 is performed by a server system participating in split training of a machine learning model, such as the server system 110 of FIG. 1. Generally, the method 400 may be performed by any computing system participating in split training of a machine learning model.

At block 405, the computing system determines a communication state to use for the current round or iteration of training. For example, in some aspects, the computing system may evaluate a variety of communication criteria to determine whether to exchange full data during the iteration (e.g., using a full data operation or workflow, such as described above with reference to FIG. 2A), or to exchange a reduced amount of data (e.g., using one of the workflow discussed above with reference to FIGS. 2B, 2C, 2D, 3A, and 3B).

Generally, the particular criteria used to determine the communication state may vary depending on the particular implementation. By way of example and not limitation, the computing system may evaluate information such as the channel state of the communication link(s) between the participating systems (e.g., the data rate, channel stability, congestion, and the like). For example, if the channel state fails to satisfy the criteria (e.g., congestion above a threshold, or data rate and/or stability below a threshold), the computing system may determine to use one or more reduced communication operations.

As another example, the computing system may evaluate the resource availability of the computing system (e.g., by determining the current workload of the computing system and what resource(s) are available for training, which may include computational or processing resources to process the training data and/or communication resources to receive and/or transmit data). For example, if the available resources fail to satisfy the criteria (e.g., the resources available are less than a threshold), the computing system may determine to use reduced communication and/or reduced computation operations.

As another example, the computing system may evaluate characteristics of the training data (e.g., based on the amount, quality, and/or distribution of data available for the current iteration). For example, if there is an insufficient number of data samples or the training data fails to meet quality criteria, the computing system may determine to use a reduced communication state.

As another example, the computing system may evaluate one or more indications of training progress for the model (e.g., by comparing the loss of one iteration with the loss from a prior iteration). For example, if the change in loss is less than a threshold, the computing system may determine to use reduced communication procedures.

In some aspects, at block 405, the computing system evaluates the various criteria to select a communication state. The computing system may indicate this selected state to the other participating system(s) (e.g., via one or more coordination or management messages). In some aspects, the other system(s) may respond in accordance with the selected operations (e.g., if the computing system is a leader or is designated to decide the state). In some aspects, the other system(s) may similarly evaluate the criteria and indicate their preferred state. The systems may then negotiate or agree on a state (e.g., to select the suggested state having the lowest communication and/or processing overhead). In some aspects, the computing system may determine the state by waiting for one or more other system(s) to indicate, to the computing system, which state to use.

In some aspects, rather than communicating their preferred states, the participating system(s) may share the relevant information used to determine or select the state (e.g., indicating their available resources), allowing a designated leader system (which may or may not be a participating system in the training) to select the state.

As discussed above, determining the state may generally include determining whether to use full, reduced (e.g., compressed), or no uplink transmissions, and/or whether to use full, reduced (e.g., compressed), or no downlink transmissions. In some aspects, if reduced uplink and/or downlink transmissions are selected, the computing system(s) may further determine which compression operation(s) (e.g., which autoencoder) to use. For example, the computing system may select a first autoencoder/autodecoder pair for uplink transmissions, and a second (different) autoencoder/autodecoder pair (or no compression at all) for downlink.

In some aspects, as discussed above, the participating systems may use one or more FSMs to determine which state to use for the subsequent iteration of training.

At block 410, the computing system determines whether the determined state (or information used to decide the state) satisfies one or more communication criteria. For example, as discussed above, the computing system may determine whether the channel is sufficiently clear, whether sufficient computing resources are available, whether sufficient training data is available, whether the training is continuing to progress, and the like.

If so, the method 400 continues to block 415, where the computing system exchanges full data (e.g., operates in a first state) while training the model. That is, the computing system performs full communication training (e.g., using the workflow 200A of FIG. 2A). As discussed above, in the full data state, the features and gradients are exchanged between the participating systems without using loss compression or reduction techniques.

Once the current round or iteration of training is completed, the method 400 then returns to block 405 to select a communication state/operation for the subsequent round training iteration.

Returning to block 410, if the computing system determines that the criteria are not satisfied (e.g., the available bandwidth is below a threshold, the computational resources are below a threshold, and the like), the method 400 continues to block 420. At block 420, the computing system exchanges reduced data (e.g., operates in a second state) while training the model. That is, the computing system performs reduced communication training of the model. For example, as discussed above, the computing system may use one or more of the workflows 200B, 200C, or 200D of FIGS. 2B, 2C, and 2D, respectively, and/or may use one or more compression operations such as discussed above with reference to the workflows 300A and 300B of FIGS. 3A and 3B, respectively.

In the illustrated example, once the current round or iteration of training is completed, the method 400 then returns to block 405 to select a communication state/operation for the subsequent round training iteration.

The method 400 may generally be repeated any number of times, such as until training termination criteria are met. Once trained, the model can then be deployed to one or more systems for inferencing. For example, in some aspects, the other participating system(s) may transmit their trained portion(s) to the computing system, and the computing system may aggregate these portions to yield a fully trained machine learning model, which can then be used for inferencing. In some aspects, the computing system similarly transmits its trained portion to the other participating system(s), allowing the other system(s) to instantiate the full model.

In some aspects, the computing system may use the split arrangement during inferencing as well. For example, the client system may continue to use the first portion of the model to process input data and generate features, which are then transmitted to the server system. The server system may then process the features using the final portion of the model to generate a prediction for the input data. Depending on the particular implementation, this prediction may then be transmitted to the client system for use, used by the server system, and/or provided to another system for use.

### Example Method for Performing Asynchronous Split Learning by a Client System

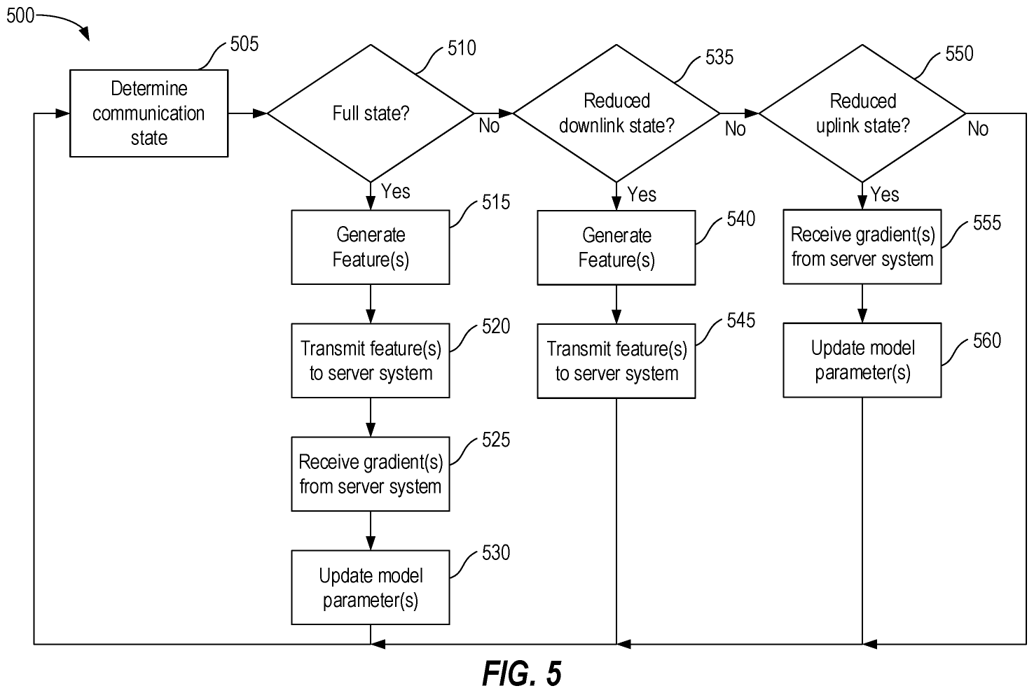

FIG. 5 is a flow diagram depicting an example method 500 for performing asynchronous split learning by a client system, according to various aspects of the present disclosure. In some aspects, the method 500 is performed by a client system participating in split training of a machine learning model, such as the client system 105 of FIG. 1. Generally, the method 500 may be performed by any computing system participating in split training of a machine learning model.

At block 505, the client system determines which communication state to use for the current iteration of training. For example, as discussed above, the client system may evaluate various criteria such as the communication channel metrics, data characteristics, training progress, and computational resource availability to determine the state (alone or in combination with the other participating system(s)).

At block 510, the client system determines whether the full state (or first state) was selected (e.g., whether to transmit full or lossless features and receive full or lossless gradients). If so, the method 500 continues to block 515, where the client system generates a set of features (e.g., the feature tensor 210 of FIG. 2A) by processing input data (e.g., the input data 205 of FIG. 2A) using a first portion of the machine learning model (e.g., the portion 125A of FIG. 2A). At block 520, the client system transmits the generated features to a server system (e.g., the server system 110 of FIG. 2A).

At block 525, the client system receives gradient(s) (e.g., the gradient tensor 230 of FIG. 2A) from the server system. For example, as discussed above, the server system may process the features (received from the client system) using a second portion of the model (e.g., the portion 125B of FIG. 2A) to generate an output, which can then be compared against a ground truth (which may be provided by the client system) to generate a loss. This loss can then be used to update the second portion (e.g., via backpropagation) to generate gradients which are then forwarded to the client system.

At block 530, the client system updates one or more model parameters (e.g., parameters of the portion 125A of FIG. 2A) based on the received gradients. In this way, both portions of the model are updated. The method 500 then returns to block 505 to determine a new state for the next iteration of training.

Although the illustrated example depicts updating the model parameter(s) independently based on each input sample (e.g., using stochastic gradient descent), in some aspects, the systems may alternatively update the model parameter(s) based on batches of inputs (e.g., using batch gradient descent) in each iteration or epoch. Further, although the illustrated example depicts returning to block 505 after each model update, in some aspects, the systems may remain in the current state for multiple such iterations prior to re-evaluating the criteria to select the next state. Additionally, in some aspects, rather than performing a defined number of iterations or epochs, the method 500 may return to block 505 in response to the occurrence of various criteria, such as identifying a sudden drop in the data rate of the communication channel.

Returning to block 510, if the client system determines that the full data state was not selected or should not be used, the method 500 continues to block 535. At block 535, the client system determines whether the reduced downlink state (or a second state) was selected (e.g., whether to transmit full or lossless features, while not receiving full or lossless gradients). If so, the method 500 continues to block 540, where the client system generates a set of features (e.g., the feature tensor 210 of FIG. 2B) by processing input data (e.g., the input data 205 of FIG. 2B) using a first portion of the machine learning model (e.g., the portion 125A of FIG. 2B). At block 545, the client system transmits the generated features to a server system (e.g., the server system 110 of FIG. 2B).

The method 500 then returns to block 505 to determine a new state for the next iteration of training. Although the illustrated example depicts returning to block 505 after transmitting the features, in some aspects, the systems may remain in the current state for multiple iterations prior to re-evaluating the criteria to select the next state. Additionally, in some aspects, rather than performing a defined number of iterations or epochs, the method 500 may return to block 505 in response to the occurrence of various criteria, such as identifying a sudden drop in the data rate of the communication channel.

Returning to block 535, if the client system determines that the reduced downlink data state was not selected or should not be used, the method 500 continues to block 550. At block 550, the client system determines whether a reduced uplink state (or a third state) was selected (e.g., whether to refrain from transmitting full or lossless features, while continuing to receive full or lossless gradients). If so, the method 500 continues to block 555, where the client system receives gradient(s) (e.g., the gradient tensor 230 of FIG. 2C) from the server system. For example, as discussed above, the server system may process features received previously from the client system (e.g., the feature(s) received during the immediately prior round of training, or the last round where features were received) using a second portion of the model (e.g., the portion 125B of FIG. 2C) to generate an output, which can then be compared against a ground truth (which may be provided by the client system) to generate a loss. This loss can then be used to update the second portion (e.g., via backpropagation) to generate gradients which are then forwarded to the client system.

At block 560, the client system updates one or more model parameters (e.g., parameters of the portion 125A of FIG. 2C) based on the received gradients. In this way, both portions of the model are updated. The method 500 then returns to block 505 to determine a new state for the next iteration of training.

Although the illustrated example depicts updating the model parameter(s) independently based on each input sample (e.g., using stochastic gradient descent), in some aspects, the systems may alternatively update the model parameter(s) based on batches of inputs (e.g., using batch gradient descent) in each iteration or epoch. Further, although the illustrated example depicts returning to block 505 after each model update, in some aspects, the systems may remain in the current state for multiple such iterations prior to re-evaluating the criteria to select the next state. Additionally, in some aspects, rather than performing a defined number of iterations or epochs, the method 500 may return to block 505 in response to the occurrence of various criteria, such as identifying a sudden drop in the data rate of the communication channel.

Returning to block 550, if the client system determines that the reduced uplink data state was not selected or should not be used, the method 500 returns to block 505. In some aspects, as discussed above, the server system may continue to train for one or more iterations or epochs (e.g., using previously provided features) during the offline state (or a fourth state). The client system, however, may wait until a subsequent iteration or round when a state transition occurs before re-joining the training.

Although the illustrated example depicts reduced communication operations that involve refraining from exchanging data in one or both directions (e.g., from the client system to the server system and/or from the server system to the client system), in some aspects, the system(s) may additionally or alternatively use dynamic compression, as discussed above. For example, at blocks 520 and/or 545, the client system may first compress the feature(s) using one or more compression techniques (e.g., using a compression operation 310 of FIG. 3A) selected based on the communication criteria, and transmit the compressed features (rather than the full uncompressed features).

Similarly, at blocks 530 and/or 560, the client system may first decompress the received gradient(s) using one or more decompression techniques (e.g., using a decompression operation 315 of FIG. 3B) selected based on which compression operation was used by the server system, and use the decompressed gradients to update the model.

### Example Method for Performing Asynchronous Split Learning by a Server System

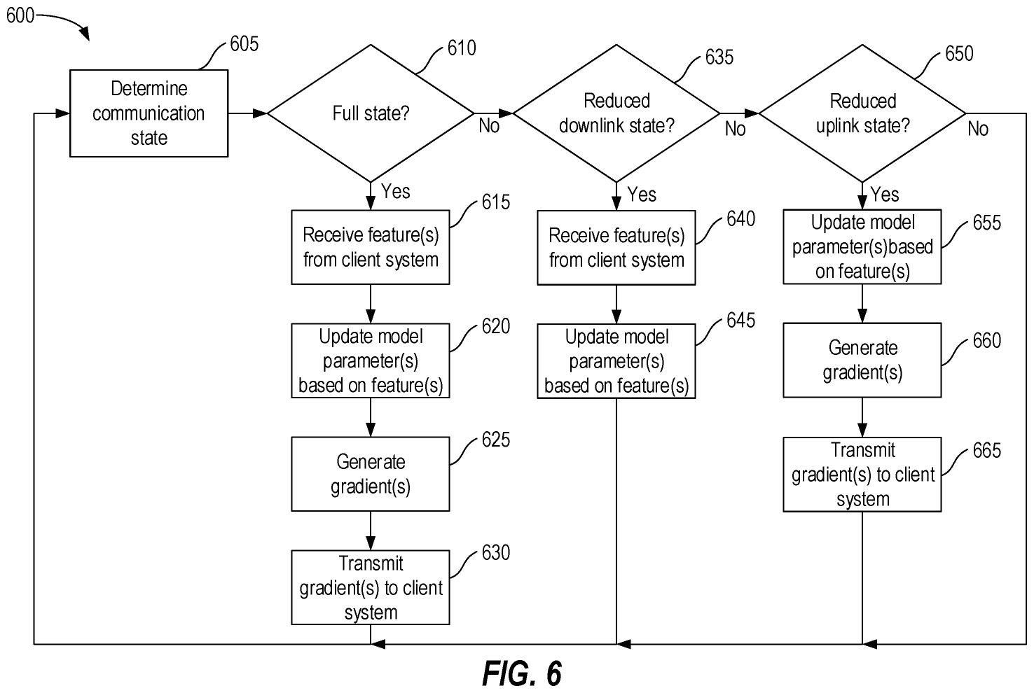

FIG. 6 is a flow diagram depicting an example method 600 for performing asynchronous split learning by a server system, according to various aspects of the present disclosure. In some aspects, the method 600 is performed by a server system participating in split training of a machine learning model, such as the server system 110 of FIG. 1. Generally, the method 600 may be performed by any computing system participating in split training of a machine learning model.

At block 605, the server system determines which communication state to use for the current iteration of training. For example, as discussed above, the server system may evaluate various criteria such as the communication channel metrics, data characteristics, training progress, and computational resource availability to determine the state (alone or in combination with the other participating system(s)).

At block 610, the server system determines whether the full state (or first state) was selected (e.g., whether to receive full or lossless features and transmit full or lossless gradients). If so, the method 600 continues to block 615, where the client system receives a set of features (e.g., the feature tensor 210 of FIG. 2A) from a client system (e.g., the client system 105 of FIG. 2A).

At block 620, the server system updates one or more mode parameters based on the received features. For example, as discussed above, the server system may process the features (received from the client system) using a second portion of the model (e.g., the portion 125B of FIG. 2A) to generate an output, which can then be compared against a ground truth (which may be provided by the client system) to generate a loss. This loss can then be used to update the second portion (e.g., via backpropagation) of the model.

At block 625, the server system generates gradients (e.g., gradient tensor 230 of FIG. 2A) based on the features. For example, as discussed above, backpropagating the loss through the second portion of the model may result in a set of gradients at the first layer of the final portion (e.g., layer 135A). These gradients may then be transmitted to the client system for use in updating the first portion of the model. In this way, both portions of the model are updated. The method 600 then returns to block 605 to determine a new state for the next iteration of training.

Although the illustrated example depicts updating the model parameter(s) independently based on each input sample (e.g., using stochastic gradient descent), in some aspects, the systems may alternatively update the model parameter(s) based on batches of inputs (e.g., using batch gradient descent) in each iteration or epoch. Further, although the illustrated example depicts returning to block 605 after each model update, in some aspects, the systems may remain in the current state for multiple such iterations prior to re-evaluating the criteria to select the next state. Additionally, in some aspects, rather than performing a defined number of iterations or epochs, the method 600 may return to block 605 in response to the occurrence of various criteria, such as identifying a sudden drop in the data rate of the communication channel.

Returning to block 610, if the server system determines that the full data state was not selected or should not be used, the method 600 continues to block 635. At block 635, the client system determines whether the reduced downlink state (or a second state) was selected (e.g., whether to receive full or lossless features, while not transmitting full or lossless gradients). If so, the method 600 continues to block 640, where the server system receives a set of features (e.g., the feature tensor 210 of FIG. 2B) from the client system. At block 645, the server system updates the second portion of the model based on the received features, as discussed above.

The method 600 then returns to block 605 to determine a new state for the next iteration of training. Although the illustrated example depicts returning to block 605 after transmitting the features, in some aspects, the systems may remain in the current state for multiple iterations prior to re-evaluating the criteria to select the next state. Additionally, in some aspects, rather than performing a defined number of iterations or epochs, the method 600 may return to block 605 in response to the occurrence of various criteria, such as identifying a sudden drop in the data rate of the communication channel.

Returning to block 635, if the server system determines that the reduced downlink data state was not selected or should not be used, the method 600 continues to block 650. At block 650, the server system determines whether a reduced uplink state (or a third state) was selected (e.g., whether to transmit full or lossless gradients, while not receiving full or lossless features).

If so, the method 600 continues to block 655, where the server system updates the model parameters (e.g., parameters of the portion 125B of FIB. 2C) based on a previous set of features. For example, as discussed above, the server system may process features received previously from the client system (e.g., the feature(s) received during the immediately prior round of training, or the last round where features were received) using a second portion of the model (e.g., the portion 125B of FIG. 2C) to generate an output, which can then be compared against a ground truth (which may be provided by the client system) to generate a loss. This loss can then be used to update the second portion (e.g., via backpropagation) to generate gradients.

At block 660, the server system generates gradients (e.g., the gradient tensor 230 of FIG. 2C) based on the prior features. For example, as discussed above, backpropagating the loss through the second portion of the model may result in a set of gradients at the first layer of the final portion (e.g., the layer 135A of FIG. 2C).

At block 665, these gradients are then transmitted to the client system for use in updating the first portion of the model. In this way, both portions of the model are updated. The method 600 then returns to block 605 to determine a new state for the next iteration of training.

Although the illustrated example depicts updating the model parameter(s) independently based on each input sample (e.g., using stochastic gradient descent), in some aspects, the systems may alternatively update the model parameter(s) based on batches of inputs (e.g., using batch gradient descent) in each iteration or epoch. Further, although the illustrated example depicts returning to block 605 after each model update, in some aspects, the systems may remain in the current state for multiple such iterations prior to re-evaluating the criteria to select the next state. Additionally, in some aspects, rather than performing a defined number of iterations or epochs, the method 600 may return to block 605 in response to the occurrence of various criteria, such as identifying a sudden drop in the data rate of the communication channel.

Returning to block 650, if the server system determines that the reduced uplink data state was not selected or should not be used, the method 600 returns to block 605. In some aspects, as discussed above, the server system may continue to train for one or more iterations or epochs (e.g., using previously provided features) during the offline state (or a fourth state) (e.g., performing blocks 655 and 660). The client system, however, may wait until a subsequent iteration or round when a state transition occurs before re-joining the training.

Although the illustrated example depicts reduced communication operations that involve refraining from exchanging data in one or both directions (e.g., from the client system to the server system and/or from the server system to the client system), in some aspects, the system(s) may additionally or alternatively use dynamic compression, as discussed above. For example, at blocks 630 and/or 665, the server system may first compress the gradient(s) using one or more compression techniques (e.g., using a compression operation 310 of FIG. 3B) selected based on the communication criteria, and transmit the compressed gradients (rather than the full uncompressed gradients).

Similarly, at blocks 615 and/or 640, the server system may first decompress the received feature(s) using one or more decompression techniques (e.g., using a decompression operation 315 of FIG. 3A) selected based on which compression operation was used by the client system, and use the decompressed features to update the model.

### Example Method for Reduced Communication Training of Machine Learning Models

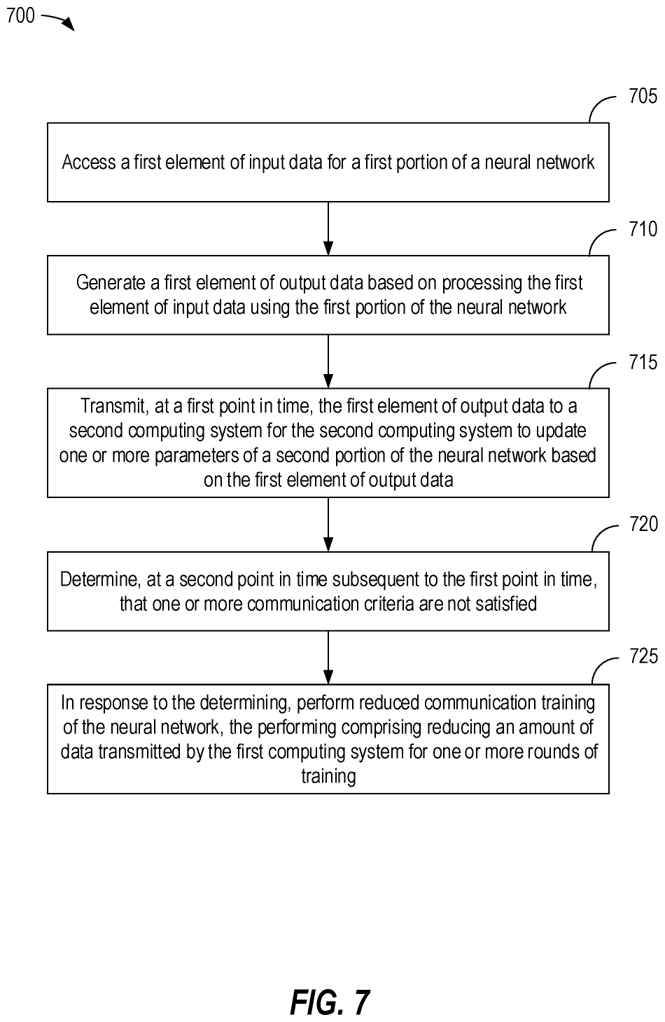

FIG. 7 is a flow diagram depicting an example method 700 for reduced communication training of machine learning models, according to various aspects of the present disclosure. In some aspects, the method 700 is performed by a client system participating in split training of a machine learning model, such as the client system 105 of FIGS. 1-3B. In some aspects, the method 700 is performed by a server system participating in split training of a machine learning model, such as the server system 110 of FIGS. 1-3B. Generally, the method 700 may be performed by a first computing system (also referred to in some aspects as a processing system) participating in split training of a machine learning model.

At block 705, a first element of input data for a first portion of a neural network is accessed.

At block 710, a first element of output data is generated based on processing the first element of input data using the first portion of the neural network.

At block 715, at a first point in time, the first element of output data is transmitted to a second computing system for the second computing system to update one or more parameters of a second portion of the neural network based on the first element of output data. For example, in cases where the first computing system is the client system, the second computing system may be the server system. As another example, in cases where the first computing system is the server system, the second computing system may be the client system.

At block 720, it is determined, at a second point in time subsequent to the first point in time, that one or more communication criteria are not satisfied.

At block 725, in response to the determining, reduced communication training of the neural network is performed, the performing includes reducing an amount of data transmitted for one or more rounds of training.

In some aspects, wherein the one or more communication criteria comprise at least one of: a state of one or more communication links between the first and second computing systems, resource availability on at least one of the first computing system or the second computing system, one or more characteristics of training data used to train the neural network, or one or more indications of training progress for the neural network.

In some aspects, wherein: the first portion of the neural network comprises one or more initial layers of the neural network, the first element of output data comprises a feature tensor output by an intermediate layer of the neural network, and the second portion of the neural network comprises one or more final layers of the neural network.

In some aspects, the method 700 further includes updating, by the first computing system, one or more parameters of the first portion of the neural network based on a set of gradients received at the first computing system from the second computing system.

In some aspects, wherein: the first portion of the neural network comprises one or more final layers of the neural network, the first element of output data comprises a gradient tensor, and the second portion of the neural network comprises one or more initial layers of the neural network.

In some aspects, the method 700 further includes generating, by the first computing system, a second element of output data based on processing the first element of input data using the first portion of the neural network and updating one or more parameters of the first portion of the neural network based on the second element of output data.

In some aspects, wherein performing the reduced communication training of the neural network comprises refraining from transmitting at least a second element of output data from the first computing system to the second computing system.

In some aspects, wherein performing the reduced communication training of the neural network further comprises receiving a second element of input data from the second computing system, and updating one or more parameters of the first portion of the neural network based on the second element of input data.

In some aspects, wherein updating one or more parameters of the first portion of the neural network comprises: generating decompressed data based on decompressing the second element of input data from the second computing system and updating one or more parameters of the first portion of the neural network based on the decompressed data.

In some aspects, wherein performing the reduced communication training of the neural network comprises transmitting at least a second element of output data from the first computing system to the second computing system, and the first computing system does not receive a second element of input data from the second computing system while performing the reduced communication training of the neural network.

In some aspects, wherein transmitting the second element of output data from the first computing system to the second computing system comprises: generating, at the first computing system, compressed output data based on compressing the second element of output data using one or more compression operations and transmitting the compressed output data from the first computing system to the second computing system.

In some aspects, wherein performing the reduced communication training of the neural network comprises generating, at the first computing system, compressed output data based on compressing at least a second element of output data using one or more compression operations and transmitting the compressed output data from the first computing system to the second computing system.

In some aspects, wherein generating the compressed output data comprises: selecting a first compression operation of the one or more compression operations based on the communication criteria and compressing the at least the second element of output data using the first compression operation to generate the compressed output data.

In some aspects, wherein performing the reduced communication training of the neural network further comprises generating a second element of input data based on decompressing received data from the second computing system and updating one or more parameters of the first portion of the neural network based on the second element of input data.

### Example Processing System for Efficient Machine Learning

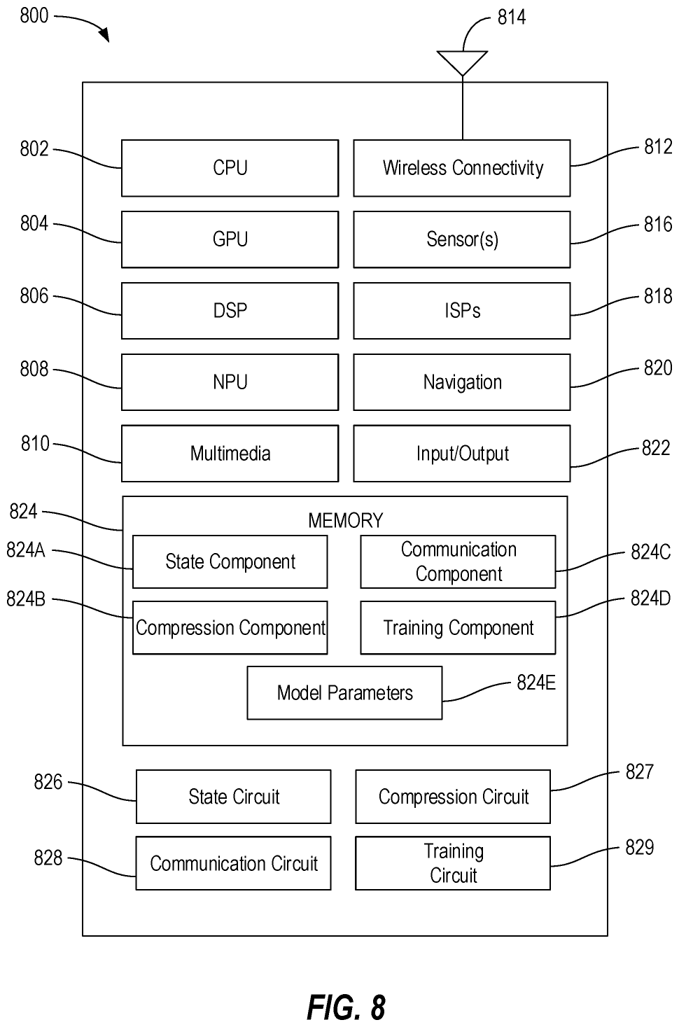

In some aspects, the workflows, techniques, and methods described with reference to FIGS. 1-7 may be implemented on one or more devices or systems. FIG. 8 depicts an example processing system 800 (also referred to in some aspects as a computing system) configured to perform various aspects of the present disclosure, including, for example, the techniques and methods described with respect to FIGS. 1-7. In some aspects, the processing system 800 may correspond to a client system, such as the client system 105 of FIGS. 1-3B. In some aspects, the processing system 800 may correspond to a server system, such as the server system 110 of FIGS. 1-3B. Generally, the processing system 800 may correspond to any computing system that participates in split training of machine learning models, as discussed above. Although depicted as a single system for conceptual clarity, in some aspects, as discussed above, the operations described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS), as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes the memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a state component 824A, a compression component 824B, a communication component 824C, and a training component 824D. The memory 824 further includes model parameters 824E for one or more models or portions thereof (e.g., parameters of the layers 130 in the portion 125A and/or parameters of the layers 135 in the portion 125B). Although not included in the illustrated example, in some aspects the memory 824 may also include other data, such as training data (e.g., the input data 205 of FIG. 2A). Though depicted as discrete components for conceptual clarity in FIG. 8, the illustrated components (and others not depicted) may be collectively or individually implemented in various aspects.

The processing system 800 further comprises a state circuit 826, a compression circuit 827, a communication circuit 828, and a training circuit 829. The depicted circuits, and others not depicted, may be configured to perform various aspects of the techniques described herein.

For example, the state component 824A and/or the state circuit 826 may be used to determine or select communication or training states, as discussed above. For example, the state component 824A and/or the state circuit 826 may evaluate criteria such as the channel state, data characteristics, training progress, and/or resource availability to determine which state should be used for a given round of training.

The compression component 824B and/or the compression circuit 827 may be used to compress and/or decompress data (e.g., features such as the feature tensor 210 of FIGS. 2A-2D and/or gradients such as the gradient tensor 230 of FIGS. 2A-2D), as discussed above. For example, the compression component 824B and/or the compression circuit 827 may use one or more compression operations (such as compression operations 310 of FIGS. 3A and 3B) to dynamically and/or selectively compress data before transmitting the data to the other participating system(s), and/or use one or more decompression operations (such as the decompression operations 315 of FIGS. 3A and 3B) to decompress any compressed data that is received from other participating system(s).

The communication component 824C and/or the communication circuit 828 may be used to communicate relevant data during training, as discussed above. For example, the communication component 824C and/or the communication circuit 828 may be used to exchange management data with the other participating system(s) (e.g., to select communication states and/or compression operations), and/or to exchange training data itself (e.g., features and/or gradients).

The training component 824D and/or the training circuit 829 may be used to process data using the machine learning model (or portions thereof) being trained, and/or to update the model (or portions thereof), as discussed above. For example, the training component 824D and/or the training circuit 829 may generate features (e.g., feature tensor 210 of FIGS. 2A and 2B) by processing input data (e.g., input data 205 of FIGS. 2A and 2B) using a first portion of the model (e.g., portion 125A of FIGS. 2A and 2B). As another example, the training component 824D and/or the training circuit 829 may generate output data (e.g., output data 215 of FIGS. 2A-2D) by processing feature data (e.g., feature tensor 210 of FIGS. 2A and 2B) using a second portion of the model (e.g., portion 125B of FIGS. 2A-2D). As another example, the training component 824D and/or the training circuit 829 may update parameters of the model (e.g., of portions 125A and/or 125B) based on gradients generated during training (e.g., gradient tensor 230 of FIGS. 2A and 2C), as discussed above.

Though depicted as separate components and circuits for clarity in FIG. 8, the state circuit 826, the compression circuit 827, the communication circuit 828, the training circuit 829 may collectively or individually be implemented in other processing devices of the processing system 800, such as within the CPU 802, the GPU 804, the DSP 806, the NPU 808, and the like.

Generally, the processing system 800 and/or components thereof may be configured to perform the methods described herein.

Notably, in other aspects, elements of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, aspects of the processing system 800 may be distributed between multiple devices.

### Example Clauses

Implementation examples are described in the following numbered clauses:

Clause 1: A method, comprising: accessing a first element of input data for a first portion of a neural network; generating, by a first computing system, a first element of output data based on processing the first element of input data using the first portion of the neural network; transmitting, from the first computing system and at a first point in time, the first element of output data to a second computing system for the second computing system to update one or more parameters of a second portion of the neural network based on the first element of output data; determining, by the first computing system at a second point in time subsequent to the first point in time, that one or more communication criteria are not satisfied; and in response to the determining, performing reduced communication training of the neural network, the performing comprising reducing an amount of data transmitted by the first computing system for one or more rounds of training.

Clause 2: A method according to Clause 1, wherein the one or more communication criteria comprise at least one of: a state of one or more communication links between the first and second computing systems, resource availability on at least one of the first computing system or the second computing system, one or more characteristics of training data used to train the neural network, or one or more indications of training progress for the neural network.

Clause 3: A method according to any of Clauses 1-2, wherein: the first portion of the neural network comprises one or more initial layers of the neural network, the first element of output data comprises a feature tensor output by an intermediate layer of the neural network, and the second portion of the neural network comprises one or more final layers of the neural network.

Clause 4: A method according to Clause 3, further comprising updating, by the first computing system, one or more parameters of the first portion of the neural network based on a set of gradients received at the first computing system from the second computing system.

Clause 5: A method according to any of Clauses 1-4, wherein: the first portion of the neural network comprises one or more final layers of the neural network, the first element of output data comprises a gradient tensor, and the second portion of the neural network comprises one or more initial layers of the neural network.

Clause 6: A method according to Clause 5, further comprising: generating, by the first computing system, a second element of output data based on processing the first element of input data using the first portion of the neural network; and updating one or more parameters of the first portion of the neural network based on the second element of output data.

Clause 7: A method according to any of Clauses 1-6, wherein performing the reduced communication training of the neural network comprises refraining from transmitting at least a second element of output data from the first computing system to the second computing system.

Clause 8: A method according to Clause 7, wherein performing the reduced communication training of the neural network further comprises: receiving a second element of input data from the second computing system; and updating one or more parameters of the first portion of the neural network based on the second element of input data.

Clause 9: A method according to Clause 8, wherein updating one or more parameters of the first portion of the neural network comprises: generating decompressed data based on decompressing the second element of input data from the second computing system; and updating one or more parameters of the first portion of the neural network based on the decompressed data.

Clause 10: A method according to any of Clauses 1-9, wherein: performing the reduced communication training of the neural network comprises transmitting at least a second element of output data from the first computing system to the second computing system, and the first computing system does not receive a second element of input data from the second computing system while performing the reduced communication training of the neural network.

Clause 11: A method according to Clause 10, wherein transmitting the second element of output data from the first computing system to the second computing system comprises: generating, at the first computing system, compressed output data based on compressing the second element of output data using one or more compression operations; and transmitting the compressed output data from the first computing system to the second computing system.

Clause 12: A method according to any of Clauses 1-11, wherein performing the reduced communication training of the neural network comprises: generating, at the first computing system, compressed output data based on compressing at least a second element of output data using one or more compression operations; and transmitting the compressed output data from the first computing system to the second computing system.

Clause 13: A method according to Clause 12, wherein generating the compressed output data comprises: selecting a first compression operation of the one or more compression operations based on the communication criteria; and compressing the at least the second element of output data using the first compression operation to generate the compressed output data.

Clause 14: A method according to any of Clauses 1-13, wherein performing the reduced communication training of the neural network further comprises: generating a second element of input data based on decompressing received data from the second computing system; and updating one or more parameters of the first portion of the neural network based on the second element of input data.

Clause 15: A method, comprising: accessing a first element of input data for a first portion of a neural network; generating a first element of output data based on processing the first element of input data using the first portion of the neural network; determining, at a first point in time that one or more communication criteria are not satisfied; and in response to the determining: generating compressed output data based on compressing the first element of output data using one or more compression operations; and transmitting, from a first computing system, the compressed output data to a second computing system for the second computing system to update one or more parameters of a second portion of the neural network based on the compressed output data.

Clause 16: A processing system comprising: a memory comprising computer-executable instructions; and one or more processors configured to execute the computer-executable instructions and cause the processing system to perform a method in accordance with any of Clauses 1-15.

Clause 17: A processing system comprising means for performing a method in accordance with any of Clauses 1-15.

Clause 18: A non-transitory computer-readable medium comprising computer-executable instructions that, when executed by one or more processors of a processing system, cause the processing system to perform a method in accordance with any of Clauses 1-15.

Clause 19: A non-transitory computer-readable medium encoding logic that, when executed by a processing system, causes the processing system to perform a method in accordance with any of Clauses 1-15.

Clause 20: An apparatus comprising logic circuitry configured to perform a method in accordance with any of Clauses 1-15.

Clause 21: A computer program product embodied on a computer-readable storage medium comprising code for performing a method in accordance with any of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first processing system comprising:
one or more memories comprising processor-executable instructions; and
one or more processors configured to execute the processor-executable instructions and cause the first processing system to:
access a first element of input data for a first portion of a neural network;
generate, by the first processing system, a first element of output data, wherein, to generate the first element of output data, the one or more processors are configured to execute the processor-executable instructions to cause the first processing system to process the first element of input data using the first portion of the neural network;
transmit, from the first processing system and at a first point in time, the first element of output data to a second processing system for the second processing system to update one or more parameters of a second portion of the neural network based on the first element of output data;
determine, by the first processing system at a second point in time subsequent to the first point in time, that one or more communication criteria are not satisfied; and
in response to the determining, perform reduced communication training of the neural network, wherein, to perform the reduced communication training of the neural network, the one or more processors are configured to execute the processor-executable instructions to cause the first processing system to reduce an amount of data transmitted by the first processing system for one or more rounds of training.

2. The first processing system of claim 1, wherein the one or more communication criteria comprise at least one of:
a state of one or more communication links between the first and second processing systems,
resource availability on at least one of the first processing system or the second processing system,
one or more characteristics of training data used to train the neural network, or
one or more indications of training progress for the neural network.

3. The first processing system of claim 1, wherein:
the first portion of the neural network comprises one or more initial layers of the neural network,
the first element of output data comprises a feature tensor output by an intermediate layer of the neural network, and
the second portion of the neural network comprises one or more final layers of the neural network.

4. The first processing system of claim 3, wherein the one or more processors are configured to further execute the processor-executable instructions to cause the first processing system to update one or more parameters of the first portion of the neural network based on a set of gradients received at the first processing system from the second processing system.

5. The first processing system of claim 1, wherein:
the first portion of the neural network comprises one or more final layers of the neural network,
the first element of output data comprises a gradient tensor, and
the second portion of the neural network comprises one or more initial layers of the neural network.

6. The first processing system of claim 5, wherein the one or more processors are configured to further execute the processor-executable instructions to cause the first processing system to:
generate a second element of output data based on processing the first element of input data using the first portion of the neural network; and
update one or more parameters of the first portion of the neural network based on the second element of output data.

7. The first processing system of claim 1, wherein, to perform the reduced communication training of the neural network, the one or more processors are configured to execute the processor-executable instructions to cause the first processing system to refrain from transmitting at least a second element of output data from the first processing system to the second processing system.

8. The first processing system of claim 7, wherein, to perform the reduced communication training of the neural network, the one or more processors are configured to execute the processor-executable instructions to further cause the first processing system to:
receive a second element of input data from the second processing system; and
update one or more parameters of the first portion of the neural network based on the second element of input data.

9. The first processing system of claim 8, wherein, to update one or more parameters of the first portion of the neural network, the one or more processors are configured to execute the processor-executable instructions to cause the first processing system to:
generate decompressed data based on decompressing the second element of input data from the second processing system; and
update one or more parameters of the first portion of the neural network based on the decompressed data.

10. The first processing system of claim 1, wherein:
to perform the reduced communication training of the neural network, the one or more processors are configured to execute the processor-executable instructions to cause the first processing system to transmit at least a second element of output data from the first processing system to the second processing system, and
the first processing system does not receive a second element of input data from the second processing system while performing the reduced communication training of the neural network.

11. The first processing system of claim 10, wherein, to transmit the second element of output data from the first processing system to the second processing system, the one or more processors are configured to execute the processor-executable instructions to cause the first processing system to:
generate compressed output data, wherein, to generate the compressed output data, the one or more processors are configured to execute the processor-executable instructions to cause the first processing system to use one or more compression operations to compress the second element of output data; and
transmit the compressed output data from the first processing system to the second processing system.

12. The first processing system of claim 1, wherein, to perform the reduced communication training of the neural network, the one or more processors are configured to execute the processor-executable instructions to cause the first processing system to:
generate compressed output data, wherein, to generate the compressed output data, the one or more processors are configured to execute the processor-executable instructions to cause the first processing system to use one or more compression operations to compress at least a second element of output data; and
transmit the compressed output data from the first processing system to the second processing system.

13. The first processing system of claim 12, wherein, to generate the compressed output data, the one or more processors are configured to execute the processor-executable instructions to cause the first processing system to:
select a first compression operation of the one or more compression operations based on the communication criteria; and
compress the at least the second element of output data, wherein, to compress the at least the second element of output data, the one or more processors are configured to execute the processor-executable instructions to cause the first processing system to use the first compression operation to generate the compressed output data.

14. The first processing system of claim 1, wherein, to perform the reduced communication training of the neural network further, the one or more processors are configured to execute the processor-executable instructions to cause the first processing system to:
generate a second element of input data, wherein, to generate the second element of input data, the one or more processors are configured to execute the processor-executable instructions to cause the first processing system to decompress received data from the second processing system; and
update one or more parameters of the first portion of the neural network based on the second element of input data.

15. A processor-implemented method, comprising:
accessing a first element of input data for a first portion of a neural network;
generating, by a first computing system, a first element of output data based on processing the first element of input data using the first portion of the neural network;
transmitting, from the first computing system and at a first point in time, the first element of output data to a second computing system for the second computing system to update one or more parameters of a second portion of the neural network based on the first element of output data;
determining, by the first computing system at a second point in time subsequent to the first point in time, that one or more communication criteria are not satisfied; and
in response to the determining, performing reduced communication training of the neural network, the performing comprising reducing an amount of data transmitted by the first computing system for one or more rounds of training.

16. The processor-implemented method of claim 15, wherein the one or more communication criteria comprise at least one of:
a state of one or more communication links between the first and second computing systems,
resource availability on at least one of the first computing system or the second computing system,
one or more characteristics of training data used to train the neural network, or
one or more indications of training progress for the neural network.

17. The processor-implemented method of claim 15, wherein:
the first portion of the neural network comprises one or more initial layers of the neural network,
the first element of output data comprises a feature tensor output by an intermediate layer of the neural network, and
the second portion of the neural network comprises one or more final layers of the neural network.

18. The processor-implemented method of claim 17, further comprising updating, by the first computing system, one or more parameters of the first portion of the neural network based on a set of gradients received at the first computing system from the second computing system.

19. The processor-implemented method of claim 15, wherein:
the first portion of the neural network comprises one or more final layers of the neural network,
the first element of output data comprises a gradient tensor, and
the second portion of the neural network comprises one or more initial layers of the neural network.

20. The processor-implemented method of claim 19, further comprising:
generating, by the first computing system, a second element of output data based on processing the first element of input data using the first portion of the neural network; and
updating one or more parameters of the first portion of the neural network based on the second element of output data.

21. The processor-implemented method of claim 15, wherein performing the reduced communication training of the neural network comprises refraining from transmitting at least a second element of output data from the first computing system to the second computing system.

22. The processor-implemented method of claim 21, wherein performing the reduced communication training of the neural network further comprises:
receiving a second element of input data from the second computing system; and
updating one or more parameters of the first portion of the neural network based on the second element of input data.

23. The processor-implemented method of claim 22, wherein updating one or more parameters of the first portion of the neural network comprises:
generating decompressed data based on decompressing the second element of input data from the second computing system; and
updating one or more parameters of the first portion of the neural network based on the decompressed data.

24. The processor-implemented method of claim 15, wherein:
performing the reduced communication training of the neural network comprises transmitting at least a second element of output data from the first computing system to the second computing system, and
the first computing system does not receive a second element of input data from the second computing system while performing the reduced communication training of the neural network.

25. The processor-implemented method of claim 24, wherein transmitting the second element of output data from the first computing system to the second computing system comprises:
generating, at the first computing system, compressed output data based on compressing the second element of output data using one or more compression operations; and
transmitting the compressed output data from the first computing system to the second computing system.

26. The processor-implemented method of claim 15, wherein performing the reduced communication training of the neural network comprises:
generating, at the first computing system, compressed output data based on compressing at least a second element of output data using one or more compression operations; and
transmitting the compressed output data from the first computing system to the second computing system.

27. The processor-implemented method of claim 26, wherein generating the compressed output data comprises:
selecting a first compression operation of the one or more compression operations based on the communication criteria; and
compressing the at least the second element of output data using the first compression operation to generate the compressed output data.

28. The processor-implemented method of claim 15, wherein performing the reduced communication training of the neural network further comprises:
generating a second element of input data based on decompressing received data from the second computing system; and
updating one or more parameters of the first portion of the neural network based on the second element of input data.

29. One or more non-transitory computer-readable media comprising computer-executable instructions that, when executed by one or more processors of one or more processing systems, cause the one or more processing systems to:
access an element of input data for a first portion of a neural network;
generate, by a first processing system, an element of output data, wherein, to generate the element of output data, the one or more processors are configured to execute the computer-executable instructions to cause the first processing system to process the element of input data using the first portion of the neural network;
transmit, from the first processing system and at a first point in time, the element of output data to a second processing system for the second processing system to update one or more parameters of a second portion of the neural network based on the element of output data;
determine, by the first processing system at a second point in time subsequent to the first point in time, that one or more communication criteria are not satisfied; and
in response to the determining, perform reduced communication training of the neural network, wherein, to perform the reduced communication training of the neural network, the one or more processors are configured to execute the computer-executable instructions to cause the first processing system to reduce an amount of data transmitted by the first processing system for one or more rounds of training.

30. A first processing system, comprising:
means for accessing an element of input data for a first portion of a neural network;
means for generating, by the first processing system, an element of output data based on processing the element of input data using the first portion of the neural network;
means for transmitting, from the first processing system and at a first point in time, the element of output data to a second processing system for the second processing system to update one or more parameters of a second portion of the neural network based on the element of output data;
means for determining, by the first processing system at a second point in time subsequent to the first point in time, that one or more communication criteria are not satisfied; and
means for, in response to the determining, performing reduced communication training of the neural network, the performing comprising reducing an amount of data transmitted by the first processing system for one or more rounds of training.
